(19) United States
(12) Patent Application Publication
(10) Pub. No.: US 2026/0028140 A1
(43) Pub. Date: Jan. 29, 2026

(54) SYSTEMS AND METHODS FOR THERMAL DISSIPATION USING A VARIABLE GEOMETRY RADIATOR

(71) Applicant: Blue Origin, LLC, Kent, WA (US)

(72) Inventors: Vishnu Sanigepalli, Los Angeles, CA (US); Zachary Begland, Kent, WA (US); Dean Bergman, Altadena, CA (US); Lily Clay, Kent, WA (US); Kayla Klein, Kent, WA (US); Richard Margulieux, Los Angeles, CA (US); Nicholas Naclerio, Kent, WA (US); Kris Zacny, Altadena, CA (US); Grayson Glazer, Kent, WA (US); Kevin Hubbard, Pasadena, CA (US)

(21) Appl. No.: 19/278,677

(22) Filed: Jul. 23, 2025

Related U.S. Application Data
(60) Provisional application No. 63/674,773, filed on Jul. 23, 2024.
(60) Provisional application No. 63/674,784, filed on Jul. 23, 2024.
(60) Provisional application No. 63/694,710, filed on Sep. 13, 2024.
(60) Provisional application No. 63/703,141, filed on Oct. 3, 2024.

(51) Int. Cl. B64G 99/00; E04H 12/18

(52) U.S. Cl. CPC B64G 99/00; E04H 12/187

(57) ABSTRACT

A lunar structure comprising: a base configured to provide active thermal energy dissipation; a retractable mast coupled to the base, the retractable mast comprising deployable interlocking actuated bands, wherein the deployable interlocking actuated bands extend in a vertical direction upward from the base; and a thermal dissipation system coupled to the base, the thermal dissipation system comprising a variable geometry radiator system configured to provide passive thermal energy dissipation, wherein the variable geometry radiator system comprises a radiator and is configured to adjust the radiator from a first position in which the radiator is in a folded configuration at the base to a second position in which the radiator is extended to form a substantially flat plane.

### CROSS-REFERENCE TO RELATED APPLICATIONS

This application claims priority under 35 U.S.C. § 119(e) to U.S. Provisional Application No. 63/674,773, entitled “SYSTEMS AND METHODS FOR LUNAR UTILITY WITH NAVIGATION, ADVANCED REMOTE SENSING, AND AUTONOMOUS BEAMING FOR ENERGY REDISTRIBUTION” and filed on Jul. 23, 2024, U.S. Provisional Application No. 63/674,784, entitled “SYSTEMS AND METHODS FOR THERMAL DISSIPATION USING A VARIABLE GEOMETRY RADIATOR” and filed on Jul. 23, 2024, U.S. Provisional Application No. 63/694,710, entitled “SYSTEMS AND METHODS FOR THERMAL DISSIPATION USING A VARIABLE GEOMETRY RADIATOR” and filed on Sep. 13,2024, U.S. Provisional Application No. 63/703, 141, entitled “SYSTEMS AND METHODS FOR THERMAL DISSIPATION USING A VARIABLE GEOMETRY RADIATOR” and filed on Oct. 3, 2024, which are hereby incorporated by reference herein in their entirety.

### BACKGROUND

Lunar traversal is challenging due to long durations with extreme temperatures and, in some places, persistent darkness. For example, the harsh environment, with extreme temperature fluctuations during the day and night, requires robust systems to regulate power to capture, store, and transfer energy. However, regions on the lunar surface may be permanently in shadow, thus solar power may be difficult to obtain. Fine, abrasive lunar dust can damage equipment and pose risks for lunar assets. Further, communication challenges between Earth and the lunar surface hinder real-time decision-making. Moreover, thermal control is a key challenge for lunar surface systems. For example, the lunar surface is a highly variable thermal environment with thermal radiation as a primary means of thermal dissipation. Due to the variable nature of thermal radiation during the lunar days, systems at the lunar surface may require variable dissipation thermal features and massive energy storage to survive weeks of extreme heat or darkness.

### SUMMARY

The systems, methods, and devices described herein each have several aspects, no single one of which is solely responsible for its desirable attributes. Without limiting the scope of this disclosure, several non-limiting features will now be discussed briefly.

One aspect of the disclosure provides a lunar structure comprising: a base comprising legs to couple to a planetary body; a retractable mast coupled to the base, the retractable mast comprising deployable interlocking actuated bands and a bellow, where the deployable interlocking actuated bands extend away from the base, and where the bellow surrounds the retractable mast; a payload coupled to a top portion of the retractable mast, the payload comprising a plurality of individual housing portions that are each configured to store an operational component; a solar power system coupled to the top portion of the retractable mast, the solar power system configured to extend downward from the top portion of the retractable mast and collect solar energy; a thermal dissipation system coupled to the retractable mast and the base, the thermal dissipation system configured to expel thermal energy from the payload to an external environment; and a thermal consolidation system coupled to the retractable mast, the thermal consolidation system configured to maintain thermal energy in an enclosure that surrounds the base.

The lunar structure of the preceding paragraph can include any sub-combination of the following features: where the solar power system comprising at least two arms extending from a top portion of the retractable mast and solar panels draped from the at least two arms; where the system is configured to rotate from a first position to a second position to allow for solar power generation to achieve a target power cycle; where the retractable mast rotates to the second position to allow for the solar power generation to achieve the target power cycle while the payload remains in a fixed position; where the target power cycle is generating solar power 90% of a time duration while the solar power system is deployed; where the thermal dissipation system comprises a variable geometry radiator configured to provide passive thermal energy dissipation at least for the payload; where the payload comprises a precision gimbaled photonic laser emitter configured to transfer power to photovoltaic array receivers associated with a lunar asset; where the payload comprises a position, navigation and timing (PNT) system configured to provide position state data to a lunar asset; where the payload comprises at least one camera configured to provide 360-degree field of view (FOV) monitoring; where the payload comprises an actuated broad-beam lighting system configured to provide illumination for an environment surrounding the system; where the payload comprises a communication system configured to communicate with at least one of a lunar asset or a second lunar structure; where the payload comprises a gimbaled communication antenna configured to provide a space communication link; where the thermal consolidation system comprises a tent that extends circumferentially around the retractable mast; where the tent extends with a diameter of greater than 5 meters; where the system is configured to be in a first configuration in which the system is stowed within a spacecraft; where the system is configured to autonomously deploy from the first configuration to a second configuration in which the system is deployed on a surface of the planetary body; where a height of the system is at least 30 meters in a configuration of the system in which the retractable mast is fully extended; where the solar power system is configured to generate at least 20 kilowatts of solar energy; where the thermal dissipation system is configured to dissipate at least 20 kilowatts of thermal energy; where the system is configured to self-deploy on a planetary body.

Another aspect of the disclosure provides a method comprising: releasing legs of a base to unfold and couple to a planetary body; extending a retractable mast to a desired height away from the base; deploying solar power system from a top portion of the retractable mast, the solar power system extends downward from the top portion of the retractable mast to collect solar energy; extending a variable geometry radiator along the retractable mast to expel thermal energy from a payload on the top portion of the retractable mast to an external environment; and deploying a thermal consolidation system at a bottom portion of the retractable mast, the thermal consolidation system extending radially from the retractable mast to maintain thermal energy in an enclosure that surrounds the base.

Another aspect of the disclosure provides a lunar structure comprising: a base configured to provide active thermal energy dissipation; a retractable mast coupled to the base, the retractable mast comprising deployable interlocking actuated bands, where the deployable interlocking actuated bands extend in a vertical direction upward from the base; and a thermal dissipation system coupled to the base, the thermal dissipation system comprising a variable geometry radiator system configured to provide passive thermal energy dissipation, where the variable geometry radiator system comprises a radiator and is configured to adjust the radiator from a first position in which the radiator is in a folded configuration at the base to a second position in which the radiator is extended to form a substantially flat plane.

The lunar structure of the preceding paragraph can include any sub-combination of the following features: where the radiator extends from the first position to the second position by extending along an axis parallel with the retractable mast in a vertical direction upwards from the base, and where the second position results in the radiator forming the substantially flat plane in the vertical direction; where the radiator is configured to adjust a position at least in response to an environmental condition; where the thermal dissipation system is positioned in a portion of the lunar structure not exposed to direct sunlight; where the radiator comprises at least two sets of variable geometry radiators; where a first set of the at least two sets of variable geometry radiators is positioned along a first side of the retractable mast, and a second set of the at least two sets of variable geometry radiators is positioned along a second side of the retractable mast; where the first side and the second side are on opposite sides of the retractable mast; where the variable geometry radiator system comprises at least four sets of variable geometry radiators; where each of the at least four sets of variable geometry radiators are positioned 90-degrees apart around the retractable mast; where the lunar structure further comprising a thermal dissipation interface coupled to the variable geometry radiator system, where the thermal dissipation interface is configured to transfer thermal energy between a lunar asset and the variable geometry radiator system.

Another aspect of the disclosure provides a method comprising: extending a retractable mast to a desired height in a vertical direction upward from a base; activating payload components at a top portion of the retractable mast; extending a radiator from a first position in which the radiator is in a folded configuration at the base to a second position in which the radiator is extended to form a substantially flat plane; and providing thermal energy dissipation to the payload components.

The method of the preceding paragraph can include any sub-combination of the following features: where the method further comprising adjusting a height of the variable geometry radiators to cause at least part of the variable geometry radiators to be in a portion of a lunar structure not exposed to direct sunlight; where providing the thermal energy dissipation to the payload components further comprising exchanging fluid with the payload components by using an active heat transport system; where the method further comprising pumping cooled fluid to the payload components and heated fluid to the radiators; where the method further comprising radiating thermal energy into an external environment surrounding the retractable mast; where the method further comprising receiving a connection from a dust tolerant connector of a lunar asset; where the method further comprising providing thermal energy dissipation to the lunar asset; where providing the thermal energy dissipation further comprising exchanging fluid with the lunar asset by using an active heat transport system; where the method further comprising pumping cooled fluid to the lunar asset and heated fluid to the radiators; where the method further comprising extending at least two sets of variable geometry radiators along an axis parallel with the retractable mast to form one or more substantially flat plane in the vertical direction.

Another aspect of the disclosure provides a system comprising a base comprising: a power source; and dust-tolerant connectors (DTC) configured to provide power distribution to lunar assets; a retractable mast comprising deployable interlocking actuated bands and solar panel bellows; and a top section comprising: a precision gimbaled photonic laser emitter configured to transfer power to photovoltaic array receivers mounted on the lunar assets; a position, navigation and timing (PNT) system configured to provide position state data for the lunar assets; at least one camera configured to provide 360-degree field of view (FOV) monitoring; an actuated broad-beam lighting system configured to provide illumination for the lunar assets; a communication system configured to allow the lunar assets to communicate without line-of-sight; and a gimbaled communication antenna configured to provide a space communication link.

Another aspect of the disclosure provides a system comprising a base. The system further comprises a thermal dissipation system comprising: a thermal dissipation interface; and a variable geometry radiator configured to dissipate thermal energy according to a geometry, where the geometry is configured to adjust in response to a thermal dissipation request from lunar assets and environmental conditions, where the thermal dissipation interface is configured to transfer thermal energy between the lunar asset and the variable geometry radiator.

### BRIEF DESCRIPTION OF DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure. To easily identify the discussion of any particular element or act, the most significant digit(s) in a reference number typically refers to the figure number in which that element is first introduced.

FIG. 1 illustrates an example environment including one or more deployable stations designed for lunar applications in accordance with the disclosure herein.

FIG. 2 illustrates example configurations for various deployment sites for stations as disclosed herein.

FIGS. 3-4 illustrate a station including a deployable structure with various components in accordance with the disclosure herein.

FIG. 5A illustrates a base of a station in accordance with the disclosure herein.

FIGS. 5B, 5C, and 5D illustrate various components of dust-tolerant connectors (DTC) as disclosed herein.

FIG. 5E illustrates a solar bellow deployed on a station in accordance with the disclosure herein.

FIG. 6 illustrates various embodiments of stations as disclosed herein.

FIG. 7 illustrates an example circuit diagram illustrating a comprehensive view of the energy distribution and management system designed for lunar applications in accordance with the disclosure herein.

FIG. 8 illustrates a station including a variable geometry radiator at the various stages of deployment in accordance with the disclosure herein.

FIGS. 9A-9B illustrate an example stations providing dissipation of thermal energy to various lunar assets in accordance with the disclosure herein.

FIG. 10 illustrates a thermodynamic architecture for efficient thermal dissipation in accordance with the disclosure herein.

FIGS. 11A-11B illustrate example stations including one or more adjustable arm in accordance with the disclosure herein.

FIG. 12 is a flow diagram illustrating a routine for deploying a station, according to some embodiments.

FIG. 13 is a flow diagram illustrating a routine for dissipating thermal energy, according to some embodiments.

FIG. 14 is a block diagram of an illustrative computing system configured to perform actions of a station, such as deploy the station and dissipation thermal energy, according to some embodiments.

### DETAILED DESCRIPTION OF SPECIFIC EMBODIMENTS

The present disclosure relates to deployable stations for providing lunar utility with navigation, advanced remote sensing, and autonomous beaming for energy redistribution capabilities. Deploying stations along the lunar surface may allow for increased communications along the surface, where each of the stations may operate as a node in a communication network. The deployable stations may include additional capabilities to provide enhanced situational awareness to personnel operating in an adjacent area. For example, the station may include energy capture, storage, and transfer capabilities to provide power to nearby personnel by transferring power with focused energy (such as laser). Moreover, the station may include thermal energy dissipation with a variable geometry radiator.

Operating on the lunar surface poses extreme challenges due to the harsh environment, with temperatures oscillating between −243 and 253-degrees Fahrenheit, dust collecting on equipment rendering electronics unusable, and the lunar day lasting for weeks. Some approaches rely on specialized equipment with advanced thermal systems and nuclear power sources because solar power, typically essential for space missions, is unavailable in dark areas (such as permanently shadowed regions (PSRs) and during lunar night). Some approaches apply autonomous navigation due to the lack of sunlight and communication delays with Earth, but this reliance poses a single point of failure if systems malfunction. In some approaches, maintaining communication may rely on relay satellites in response to direct links are often obstructed, adding layers of complexity and potential failure points. Thermal management systems and artificial lighting for short-term tasks consume valuable energy, further complicating operations. These challenges, including the need for sustainable power and reliable communication, pose significant risks and emphasize the necessity for technological advancements to ensure mission success and personnel safety.

Some aspects of the present disclosure address some or all of the issues noted above, among others, by providing a deployable structure that integrates energy harvest and storage, communications, mesh network, Position, Navigation, and Timing (PNT), power transfer, and surveillance into a single infrastructure. The architecture can integrate into the volume and mass constraints of the landing systems. Through strategic site selection and multi-deployments, the systems described herein can generate operational power needs required for surviving lunar nights. Compared to some approaches, the systems have capability to generate power on average of 94% of the time including lunar nights throughout a 20-year lunar precession cycle. To transfer power to other lunar assets, the systems disclosed herein use a precision gimbaled photonic laser emitter on top of the deployable structure to that emits energy to photovoltaic array receivers mounted on various lunar assets. In this way, the focused energy allows for long-range power transmission between assets without the need for heavy harnessing that needs to be routed in-between multiple systems. The systems disclosed herein have a compact and localized PNT system to provide position state data for landers, rovers, and astronauts for navigation during critical extravehicular activities. Due to the limited view factors inside craters and PSRs, the systems disclosed provide continuous PNT services that some approaches cannot. The systems provide for 360-degree field of view (FOV) cameras and the actuated broad-beam lighting system allows critical asset monitoring to help Earth and Lunar Mission Control to oversee autonomous robotic systems and extravehicular activities. As the number of deployments scale and are strategically placed, communications systems for the stations evolve into a mesh communication network that allows any lunar asset to communicate with another without line-of-sight. A gimbaled communication antenna at the top of the structure also provides Direct-To-Earth (DTE) communications with Space Network (SN) or Deep Space Network (DSN) with higher degree of visibility based on the deployed location. The communication services can be extended with data storage capability and lunar network services at the base of each system to serve as a decentralized network to store, transmit, and provide mission data as required.

Some approaches develop lunar systems with customized thermal control subsystem. In this way, radiators include designs and size for peak thermal load and with the ability to be isolated to avoid freezing at night. In this way, the thermal dissipation systems include high-capacity electric batteries to provide heater power through the lunar night. However, the inability to consolidate the custom thermal control subsystems results in excessive weight associated to the thermal dissipation, thus the inability to traverse the lunar surface.

Some aspects of the present disclosure address some or all of the issues noted above, among others, by providing efficient thermal control on the lunar surface. Unlike other approaches, systems disclosed herein consolidate thermal management into a shared microgrid. This system features large deployable radiators with in-built fluid pump loops, accumulators, valves, and controllers, allowing multiple users and payloads to offload their thermal dissipation needs. The variable geometry radiators provide a highly efficient deployed radiator and active cooling system to dissipate greater than 10 kilowatt of thermal energy (kWt). In this way, the systems described herein provide efficient thermal management that is adjustable for the needs of lunar assets.

Various aspects of the disclosure will now be described with regard to certain examples and embodiments, which are intended to illustrate but not limit the disclosure. Although aspects of some embodiments described in the disclosure will focus, for the purpose of illustration, on particular examples of lunar infrastructure, service providing for in-situ resource utilization, and deployment of lunar bases, the examples are illustrative only and are not intended to be limiting. In some embodiments, the techniques described herein may be applied to additional or alternative lunar infrastructure, service providing for in-situ resource utilization, and deployment of lunar bases, and the like. Additionally, any feature used in any embodiment described herein may be used in any combination with any other feature or in any other embodiment, without limitation.

### Example Environment for Deployable Stations

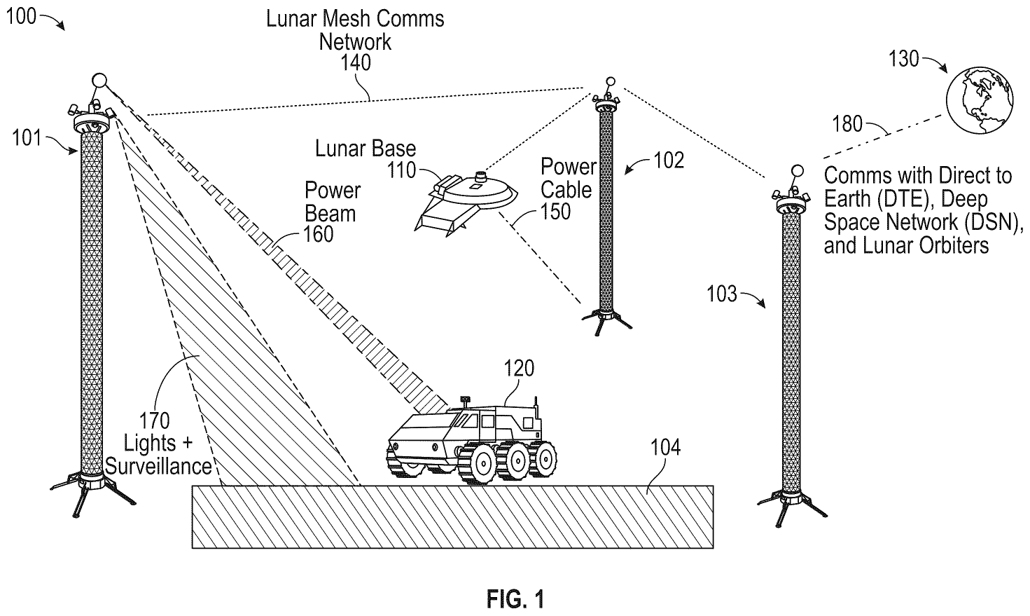

FIG. 1 illustrates an example environment 100 including one or more deployable stations (may also be referred to herein as “lunar structure”) designed for lunar applications. The environment 100 may include components to provide for energy harvesting and energy storage, communications, mesh networking, PNT, power transfer, and surveillance.

The first station 101, second station 102, and the third station 103 in the environment 100 may each provide essential services such as energy harvesting, communication, and surveillance. In some examples, the stations 101,102, 103 each may be standing laterally along a surface 104. In some cases, the stations 101, 102, 103 may be between 0 and 500 meters (m) tall, or any value or range between any of these values or ranges or any value or range bounded by any combination of these values, although values or ranges outside these values or ranges can be used in some cases. In some cases, the stations 101, 102, 103 may have a diameter between 0 and 5 m, or any value or range between any of these values or ranges or any value or range bounded by any combination of these values, although values or ranges outside these values or ranges can be used in some cases.

The stations 101, 102, 103 may include a modular component to include various components. For example, the modular component may include solar panels, communication antennas, and surveillance equipment, ensuring robust functionality in the lunar environment. The stations 101, 102, 103 may have a length-to-diameter ratio between 10:1 to 100:1, or any value or range between any of these values or ranges or any value or range bounded by any combination of these values, although values or ranges outside these values or ranges can be used in some cases, making the stations 101, 102, 103 efficient for space-constrained deployments. In some examples, the stations 101, 102, 103 may include structures that can integrate into lunar architectures with an ability to scale by size to fit the volume and mass constraints of the landing systems. The stations 101, 102, 103 may be of different sizes with respect to diameter and height. As stations increase in diameter and height, power generation scales linearly. These two parameters (diameter/height) can be adjusted based on customer/mission requirements such as: power requirement, launch up-mass and down-mass, volume capability, and so on. In some examples, the stations 101, 102, 103 may include solar panels mounted. In some cases, the solar panels may generate up to 150 kilowatts (KW) of power during the lunar day, providing a reliable source of energy for the system. In some cases, the stations 101, 102, 103 may store the energy. For example, the stations 101,102, 103 may include a battery. The battery may have a capacity of 50 kW-hour (kWh) and a 60% depth of discharge, ensuring continuous operation during the lunar night, or any value or range between any of these values or ranges or any value or range bounded by any combination of these values, although values or ranges outside these values or ranges can be used in some cases. In some cases, part of the stations 101, 102, 103 may receive sunlight as the sun would illuminate the top of the solar panel assembly, such that the power generation may be at partial (or full) capacity it would allow for a power redundancy for self-survival and the capacity to beam power to other assets. In some cases, the stations 101, 102, 103 may provide surveillance and navigation services, ensuring comprehensive coverage of the lunar surface and enhancing mission safety. In some examples, the stations 101, 102, 103 may include a gimbaled photonic laser emitter for long-range power transmission, enabling efficient energy redistribution across the lunar surface without the need for heavy harnessing. The laser emitter precisely aims to target specific assets, optimizing energy transfer efficiency.

In some examples, the stations 101, 102, 103 may provide various functions to personnel in the environment 100. For example, the stations 101, 102, 103 may provide communication capabilities to a lunar base 110 via mesh communication network 140 and/or power cable 150. The lunar base 110 may benefit from the energy and services provided by the system, enhancing its operational capabilities and supporting sustained lunar activities. The lunar base 110 may house astronauts, scientific equipment, and other essential infrastructure, making it a critical component of lunar missions. In some examples, the stations 101, 102, 103 may include gimbaled communication components. For example, the gimbaled design allows the antenna to track and maintain a stable connection with moving targets, ensuring uninterrupted communication.

The mesh communication network 140 may form through multiple deployments of the stations 101, 102, 103. In some cases, the mesh communication network 140 may provide for communication between lunar assets without line-of-sight. The mesh communication network 140 enhances the reliability and efficiency of communication on the lunar surface. The mesh communication network 140 may adjust as more stations are deployed, providing robust and scalable communication infrastructure that adapts to the growing needs of lunar missions. The mesh communication network 140 may support high-bandwidth data transfer, enabling advanced applications such as teleoperation and real-time video streaming. The mesh communication network 140 may follow designs to include data storage capabilities and lunar network services at the base of each system, serving as a decentralized network for mission data storage and transmission.

The lunar base power cable 150 may connect the lunar base 110 to the stations 101, 102, 103, facilitating the transfer of harvested energy to the base 110. The power cable 150 may ensure a stable and continuous power supply for operations of the base 110. The power cable 150 may be robust and flexible, allowing the power cable 150 to be routed around obstacles and integrated into the base 110 infrastructure. The power cable 150 may include dust-tolerant connectors to maintain reliable connections in the environment 100.

In some examples, the stations 101, 102, 103 may provide communication capabilities to lunar assets 120 via a power beam 160. The lunar assets 120 may include components such as exploration equipment and personnel, such as a lunar rover. In some examples, the lunar assets 120 may rely on the stations 101, 102, 103 for navigation, communication, and power needs. The stations 101, 102, 103 may provide support for operations, ensuring mission success and enabling efficient resource utilization on the lunar surface. The lunar assets 120 may perform tasks such as exploration, sample collection, and construction. For example, the stations 101, 102, 103 may provide PNT services to identify position state data for landers, rovers, and astronauts, ensuring continuous navigation services in areas with limited visibility, such as craters and permanently shadowed regions (PSRs).

The power beam 160 may transfer power from the stations 101, 102, 103 to the lunar assets 120. In some examples, the power beam 160 may be a photonic laser to transfer power from the stations 101, 102, 103 to other lunar assets equipped with photovoltaic array receivers. The power beam 160 may enable long-range power transmission, which ensures efficient energy redistribution across the lunar surface. In this way, supporting various lunar operations and enhancing mission flexibility. The power beam 160 may be capable of autonomously aiming to target specific assets, optimizing energy transfer efficiency. The stations 101, 102, 103 may produce the power beam 160 using a precision gimbaled mechanism to ensure accurate targeting and efficient energy transfer. For example, the gimbaled design allows the transmitter to track and maintain a stable connection with moving targets, ensuring little to no interruptions for power transfer.

In some examples, the stations 101, 102, 103 may communicate with the Earth 130 via a space communication link 180. represents the communication link between the system and Earth-based mission control and data centers. The space communication link 180 may provide for real-time data transmission and remote control of lunar operations. For example, the space communication link 180 may allow for the transmission of scientific data, operational commands, and status updates, ensuring that mission control can make informed decisions. In some cases, the stations 101, 102, 103 include a gimbaled communication antenna. The space communication link 180 may include Direct-To-Earth (DTE) communications with the Space Network (SN) or Deep Space Network (DSN), ensuring high visibility and reliable data transmission. In some cases, the space communication link 180 may provide continuous communication with Earth 130. In this way, one or more of the stations 101, 102, 103 may establish a position to circumvent solar adjustments according to lunar libration.

In some examples, the stations 101, 102, 103 may include lights 170 to provide illumination for personnel or other applications. In some examples, the stations 101, 102, 103 may include 360-degree field-of-view cameras and a broad-beam lighting system. The lights 170 may provide illumination of areas, enabling nighttime operations and improving visibility in shadowed regions. These components may provide comprehensive monitoring of lunar assets and activities, offering real-time data to mission control. In some examples, the stations 101, 102, 103 may include a surveillance system to monitor a surrounding part of the environment 100. For example, the surveillance system may enhance mission safety and efficiency by overseeing autonomous robotic systems and extravehicular activities, ensuring situational awareness and operational control. Engineers designed the cameras and lighting system to withstand the harsh lunar environment, ensuring reliable performance over extended periods.

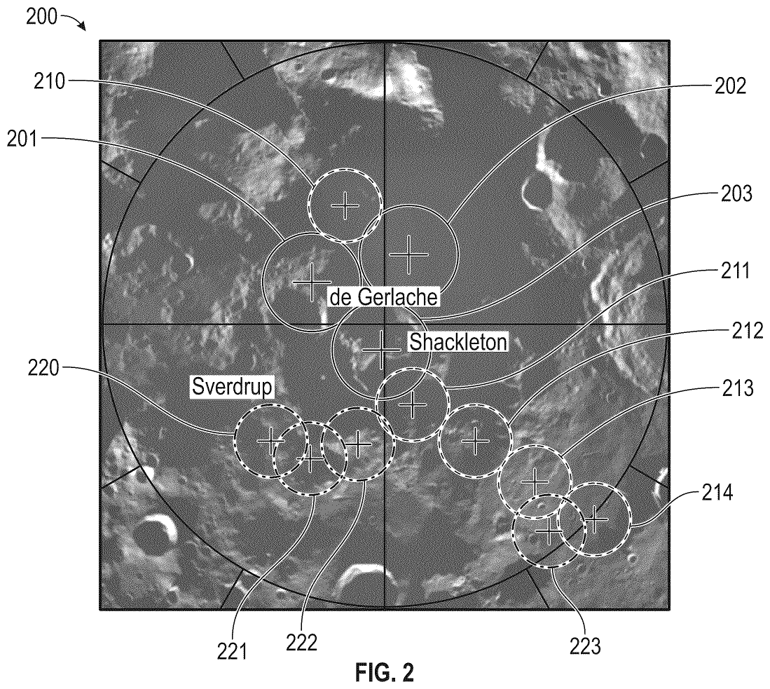

FIG. 2 illustrates example configurations 200 for various deployment sites for stations as disclosed herein (for example, stations 101, 102, 103 in FIG. 1). The configurations 200 may include stations positioned along terrain, including geographical features such as craters, ridges, and plains. Deploying the stations across different regions may provide expansive coverage for lunar assets and personnel, ensuring robust functionality and continuous operation. The first deployment site 201, second deployment site 202, and the third deployment site 203 may cover an arca on the surface to provide coverage for various functionality as described herein. For example, the deployment sites 201, 202, 203 may include stations with communication capabilities to reach a further point along the surface 200. In this way, the stations positioned at the deployment sites 201, 202, 203 may be larger than stations positioned at the other regions. For example, the deployment sites 201, 202, 203 may be chosen based on factors such as solar exposure, communication line-of-sight, and proximity to other lunar assets. In this way, the stations positioned at the deployment sites 201, 202, 203 establish nodes in an overall network of stations. In this way, the stations may provide essential services such as energy harvesting and communication.

In some examples, other configurations of stations are available to provide functions and services for lunar assets, including personnel. For example, the configurations 200 may include a fourth region 210, fifth region 211, sixth region 212, seventh region 213, eighth region 214, ninth region 220, tenth region 221, eleventh region 222, and twelfth region 223. The sites for the regions may include locations for additional stations. In some examples, the stations for the regions may be chosen to further expand the network's reach and improve overall system performance. In some examples, the regions may provide additional energy harvesting, communication, and surveillance capabilities, ensuring comprehensive coverage of the lunar surface for overlapping regions. For example, some or all of the regions may interact to increase service capability when associated stations scale and set up in network with the stations as nodes. In this way, the stations acting as nodes may access data across lunar assets without line-of-sight. The stations may provide data storage capabilities. For example, providing a data storage services for asset monitoring, science data, or decentralized lunar network. The network of the deployment sites 201, 202, 203 and any of the regions may provide power checkpoints to provide power to lunar assets for transit across the surface for extended periods of time. The stations acting as nodes may provide PNT services, such as high accuracy position state as the number of deployments scale. In this way, the stations may provide space traffic control to monitor and regulate space traffic while providing PNT services for more precision landing.

### Example Deployable Station

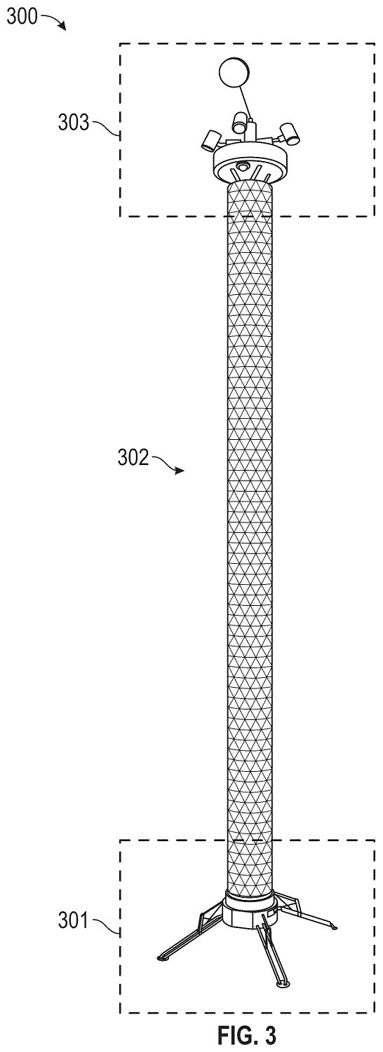

FIG. 3 illustrates a station 300 including a deployable structure with various components. The station 300 and the stations 101, 102, and 103 may be the same or different. In some examples, the station 300 provides customizability to fit various mission profiles, providing a robust and versatile solution for operations (such as on the lunar surface). The station 300 includes a base section 301, a mast section 302, and a top section 303. The base section 301 provides a stable foundation for deployment of the mast section 302. In some examples, the base section 301 may include foldable stands to provide space between a surface and the base section 301. For example, various foldable stands may adjust from a lateral position along the mast section 302 to rotate and lock into position to balance the station 300 in a position perpendicular to the surface. In some examples, the base section 301 may include a self-leveling mechanism to ensure stability on uneven lunar terrain. For example, the base section 301 may include an accelerometer to measure changes in position of the station 300. The mast section 302 may include an elongated structure connecting the base section 301 to the top section 303. In some examples, the mast section 302 may have dimensions as described herein (for example, height, diameter, ratios, etc.). The top section 303 may include additional components to provide capabilities for the station 300. For example, energy transfer, communication, and surveillance. In some examples, the top section may include additional communication modules to support high-bandwidth data transfer and/or advanced imaging systems for detailed surface mapping and analysis.

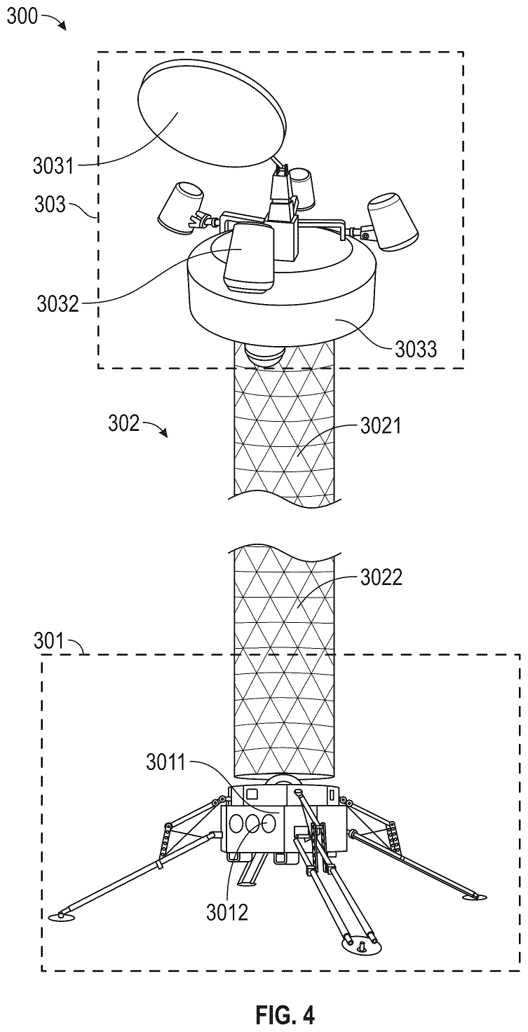

FIG. 4 illustrates the station 300 as disclosed in FIG. 3. The station 300 may integrate multiple functionalities, including energy harvesting, storage, communications, mesh networking, Position, Navigation, and Timing (PNT), power transfer, and surveillance. The station 300 includes the base section 301, the mast section 302, and the top section 303.

The base section 301 further includes a base 3011 and a breakout panel 3012. The base 3011 may provide structural foundation for the station 300. In some examples, the base 3011 may include batteries, sized appropriately to survive and provide power to other lunar assets. The base 3011 may include a self-leveling mechanism to ensure stability on uneven lunar terrain. In some examples, the base may incorporate a modular design, allowing for the integration of additional components as needed. In some examples, the base 3011 may include legs to provide support for the station 300. For example, the legs may be anchored legs to provide additional stability margins for moonquakes and thermal shocks during lunar eclipses. In some cases, the legs may be foldable stands that adjust from a lateral position along the mast to rotate and lock into position, balancing the system in a position perpendicular to the lunar surface. The base 3011, and other components of the station 300, may minimize solar deflection and increase stability margins of the station 300.

The breakout panel 3012 may include a power distribution panel for power transfer to surface assets (e.g., science payloads, habitats, ISRU instrumentation) and re-charge rovers. In some examples, the breakout panel 3012 may include dust-tolerant connectors (DTC) for reliable connections in the lunar environment. The connectors ensure stable and continuous power supply and communication links, even in the presence of fine, abrasive lunar dust. In some examples, the DTCs may include one or more connectors to support various types of connections. For example, the DTCs may include a universal connection type. The connectors may provide capabilities such as power, data, and fluid transfer. In another example, the breakout panel may feature a protective cover to shield the connectors from lunar dust when not in use. In some examples, the breakout panel 3012 may include an automated cleaning mechanism to remove dust from the connectors, ensuring reliable connections at all times.

The mast section 302 may include deployable interlocking actuated bands 3021 and a solar panel bellow 3022. The deployable interlocking actuated bands 3021 may provide a helical band actuator that stores and deploys a retractable mast including rigid tubular materials. The interlocking actuated bands 3021 may include a single piece of sheet metal wound in a spiral configuration, such that a side of the interlocking actuated bands 3021 may interconnect as the interlocking actuated bands 3021 unravel. In some examples, the deployable interlocking actuated bands 3021 may feature a locking mechanism to secure the mast in place once fully deployed. In some examples, the deployable interlocking actuated bands 3021 may include a retractable design, allowing for compact storage during transport and deployment. For example, the interlocking actuated bands 3021 may adjust a length according to application. In some cases, the interlocking actuated bands 3021 may increase or decrease length to allow part or all of the station 300 to receive sunlight. In some examples, the interlocking actuated bands 3021 may include a diameter of between 0 and 10 m, or any value or range between any of these values or ranges or any value or range bounded by any combination of these values, although values or ranges outside these values or ranges can be used in some cases. The techniques to bind the interlocking actuated bands may be further described in greater detail in U.S. Provisional Application US 63/571,421 and titled “DEPLOYABLE INTERLOCKING ACTUATED BANDS FOR LINEAR OPERATIONS,” which is hereby incorporated by reference in its entirety.

The solar panel bellow 3022 is a deployable solar panel system to traverse at least part of a length of the mast section 302. In some examples, the solar panel bellow 3022 may utilize origami bellows made of flexible printed circuits (FPC) to stow the solar panels in a folded origami bellow for launch and is deployed by the mast section 302. In this way, the origami design allows for compact storage and efficient deployment, maximizing the surface area for power harvesting. In some examples, the solar panel bellow 3022, and/or panels of the solar panel bellow 3022, may drape from the top section 303. For example, the solar panel bellow 3022 may appear similar to a sail extending from the station 300. In some cases, the solar panel bellow 3022 may rotate in various directions to capture energy (such as solar energy). The power is transmitted via built-in circuitry within the FPCs to the base section 301 and top section 303. The solar panel bellow 3022 may include a variety of individual solar panel sections. The solar panel bellow 3022 may surround the retractable mast of the mast section 302 to provide a full 360-degree FOV, and therefore can generate power from solar energy in all directions or angles without additional actuation. In this way, the solar panel bellow 3022 may be similar in shape to a cylinder, with a central opening to receive the retractable mast of the mast section 302. In some examples, the solar panel bellow 3022 may include a length of between 0 m and the length of the mast section, for example, 200 m, or any value or range between any of these values or ranges or any value or range bounded by any combination of these values, although values or ranges outside these values or ranges can be used in some cases. The solar panel bellow 3022 may have a diameter of between 0 and 10 m, or any value or range between any of these values or ranges or any value or range bounded by any combination of these values, although values or ranges outside these values or ranges can be used in some cases. The solar panel bellow 3022 may include an area of between 0 and 5000 m². In some examples, the solar panel bellow 3022 may generate up to 150 kW of power during the lunar day, providing a reliable source of energy for the station 300. In some examples, the solar panel bellow 3022 may include integrated tracking systems to adjust an orientation towards the sun. In some examples, the solar panel bellow 3022 may include a modular design, allowing for easy replacement or upgrading of individual sections. In some examples, the solar panel bellow 3022 may incorporate advanced materials to enhance the efficiency and durability of the solar panels in the lunar environment. Although FIG. 3 discloses a solar panel bellow 3022, the present disclosure is not limited as such. The solar panel bellow 3022 may be a bellow without solar panels, for example, surrounding the interlocking actuated bands 3021. In this way, the bellow may provide various functions for the interlocking actuated bands 3021, such as, thermal insulation, physical protection from impact, and/or the like.

The top section 303 may include a plurality of individual housing portions that are configured to store operational components. For example, the top section 303 may include a power beam 3031, a broad beam light 3032, and a communication system 3033. The power beam 3031 functions as a photonic laser emitter used to transfer power from the system to other lunar assets. For example, providing power to lunar assets equipped with photovoltaic array receivers. The power beam 3031 may enable long-range power transmission without heavy harnessing. The power beam 3031 may transfer power to lunar assets for continuous lunar operations as well as survival power for thermal, avionics and communications. The power beam 3031 may include a pan and tilt gimbal to provide full 360-degree coverage to transfer energy to assets within line-of-sight. The power beam 3031 may ensure efficient energy redistribution across the lunar surface, supporting various lunar operations and enhancing mission flexibility. The power beam 3031 can adjust an aim to target specific assets, optimizing energy transfer efficiency. The power beam 3031 may include a 2-axis precision gimbaled mechanism to ensure accurate targeting and efficient energy transfer. In some examples, the power beam 3031 may include adaptive optics to compensate for atmospheric distortions and enhance beam quality. In some examples, the power beam 3031 may feature a modular design, allowing for easy replacement or upgrading of individual components. In some examples, the power beam 3031 may adjust a position according to vibrations from surface operations and environmental factors. For example, adjust according to solar, moonquakes, actuator vibrations, etc.

The broad beam lights 3032 may provide illumination for personnel and other applications. The broad beam lights 3032 may enable nighttime operations and improve visibility in shadowed regions. In some examples, the broad beam lights 3032 may include adjustable intensity settings to accommodate different lighting needs. In some examples, the broad beam lights 3032 may include adjustable intensity settings to accommodate different lighting needs. For example, the intensity can be increased for detailed work or reduced to conserve energy. In some examples, the broad beam lights 3032 may include high-efficiency LEDs with advanced thermal management systems to ensure optimal performance and longevity.

The communication system 3033 may include an omni-directional antenna, GPS, and fiducials. The omni-directional antenna provides Direct-To-Earth (DTE) communications with the Space Network (SN) or Deep Space Network (DSN), ensuring high visibility and reliable data transmission. The GPS component provides position state data for landers, rovers, and astronauts, ensuring continuous navigation services in areas with limited visibility, such as craters and permanently shadowed regions (PSRs). The fiducials enhance the accuracy and reliability of the navigation and communication systems. In some examples, the communication system 3033 may include additional communication modules to support high-bandwidth data transfer. For example, the modules can enable real-time video streaming and large data uploads. In some examples, the GPS component may feature advanced algorithms to improve positioning accuracy and reliability. These algorithms can enhance the system's ability to navigate and track assets in challenging environments. In some examples, the communication system 3033 may incorporate environmental sensors to monitor conditions such as temperature, radiation, and dust levels, providing valuable data for mission planning and operations. These sensors can help detect and respond to environmental hazards. The communication system 3033 may be constructed from lightweight, high-strength materials such as aluminum alloys or titanium to ensure durability and case of deployment.

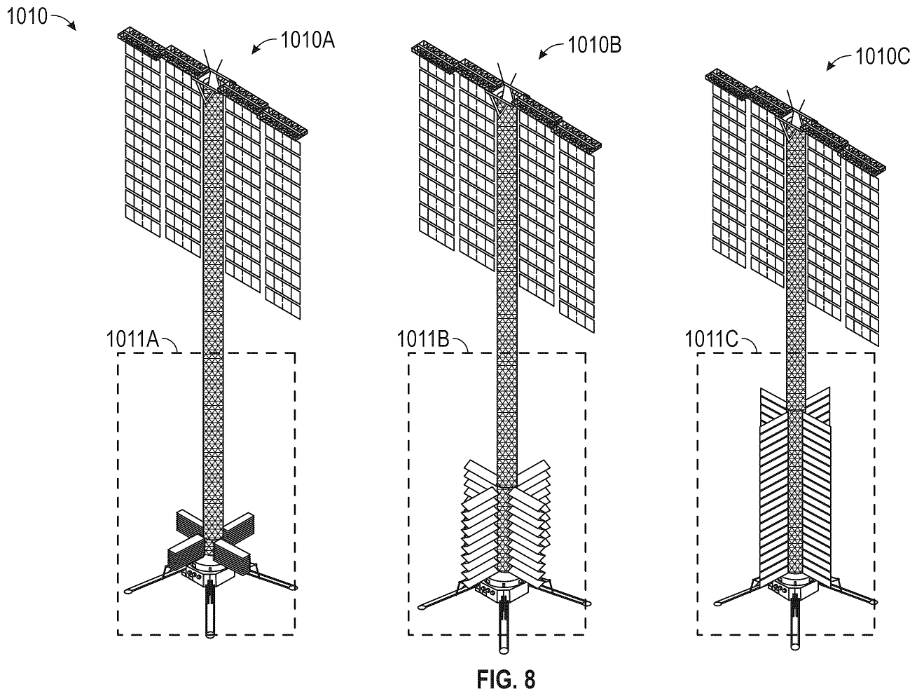

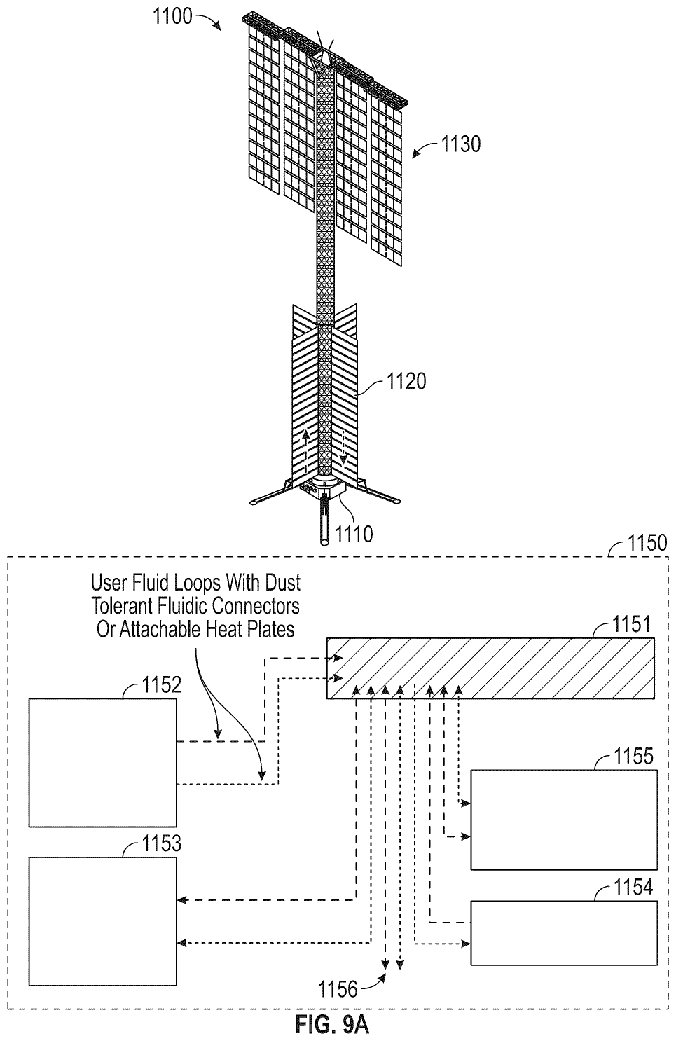

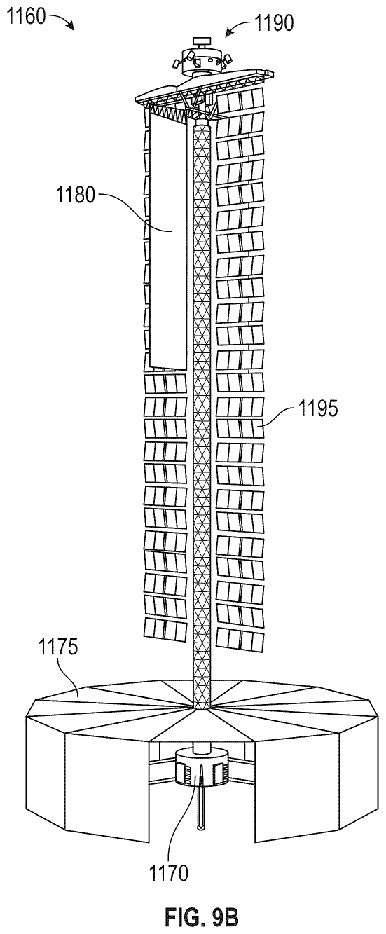

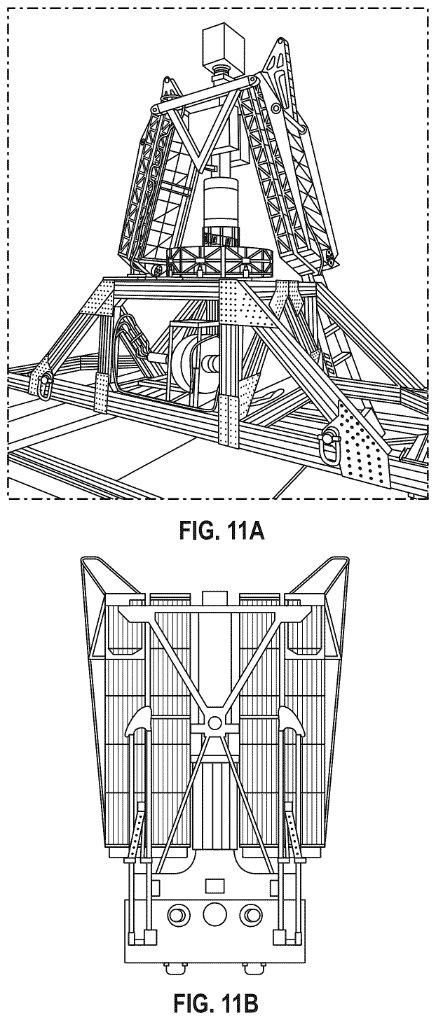

In some examples, the top section 303 may include a first portion for a payload and a second portion for a solar panel system. For example, the first portion may be as illustrated in FIGS. 3-4, including a platform with various housing components for each component of the payload. In some cases, a second portion may be as the payload 1130 as illustrated in FIG. 9A, including various draped solar panels extending downward from the top section (such as, top section 303). In some examples, the second portion may include arms (such as those described in FIGS. 11A-11B) that extend laterally from the top section 303. Each of the arms may include components, such as the solar panel system, a thermal dissipation system (as described in FIGS. 8-10), and/or the like. The first portion may be in any configuration with respect to the second portion. For example, the first portion may be above the second portion, the first portion and the second portion may be in the same horizontal or vertical plane, the first portion and the second portion may be on opposite sides of the mast section, and/or the like.

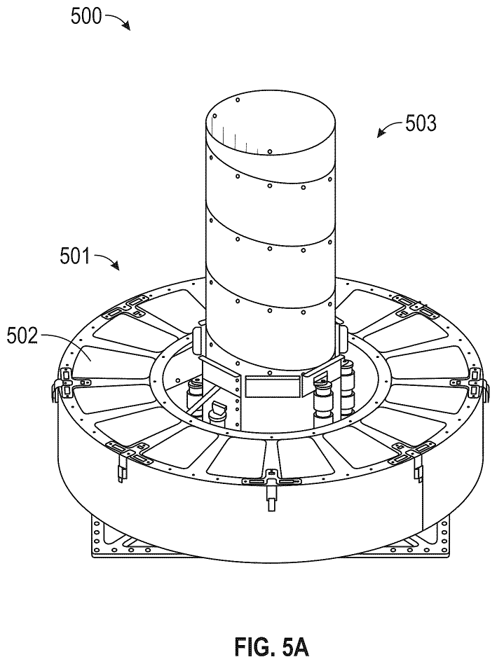

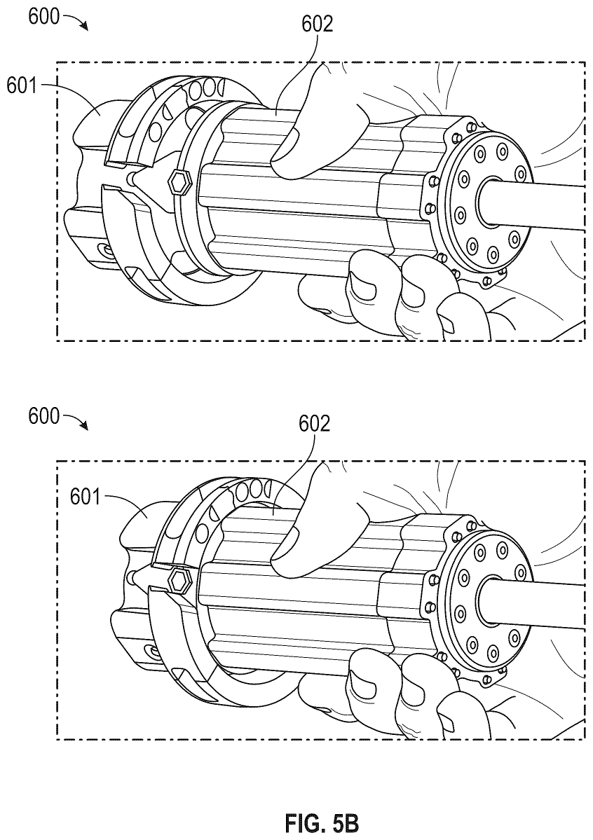

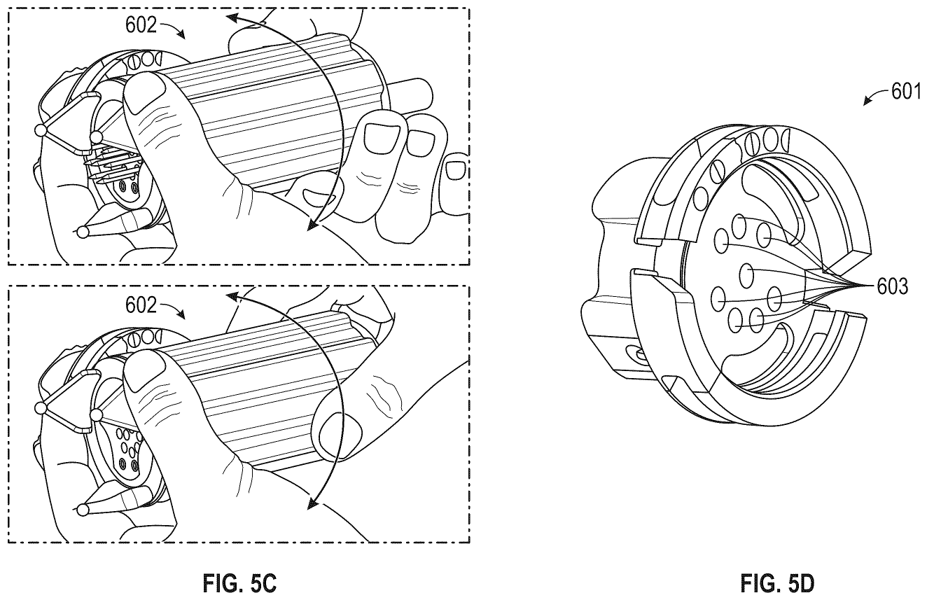

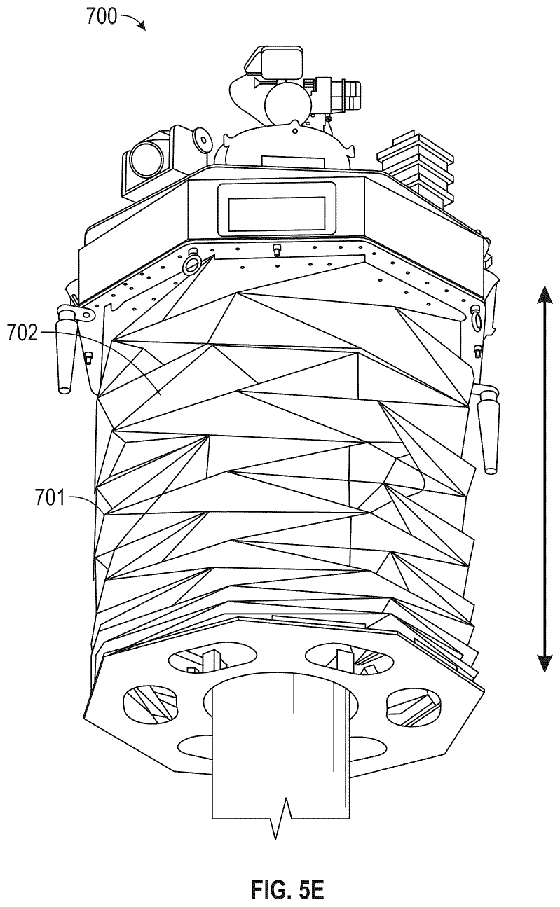

FIGS. 5A, 5B, 5C, 5D, and 5E illustrate various components of a station as disclosed herein. FIG. 5A illustrates part of a base 500 of a station (such as base section 301 in FIG. 3). The base 500 may include sheet metal housing component 501, sheet metal winding 502, and a deployable structure 503. In some examples, the sheet metal housing component 501 may include sheet metal winding 502. The sheet metal winding 502 may be unraveled to protrude from an opening of the sheet metal housing component 501. The sheet metal winding 502 may bind together to form a retractable mast of the deployable structure 503. For example, the techniques to bind the sheet metal winding 502 may be further described in greater detail in U.S. Provisional Application US 63/571,421 and titled “DEPLOYABLE INTERLOCKING ACTUATED BANDS FOR LINEAR OPERATIONS,” which is hereby incorporated by reference in its entirety. In some examples, the deployable structure 503 may be in a spiral configuration. The components at center of sheet metal housing component 501 may act to bind the sheet metal winding 502 to form a spiral away from the base. In some examples, the amount of metal in the sheet metal winding 502 may correspond to a height of the mast. FIGS. 5B, 5C, and 5D illustrate parts of a base section including a DTC 600. The DTC 600 may include a first component 601 and second component 602. The first component 601 includes cavities 603 configured to receive a connector piece from the second component 602. In this way, the first component 601 and the second component 602 may couple to form a connected configuration of the DTC 600. FIG. 5E illustrates an examples solar panel bellow 700. The solar panel bellow 700 includes a frame structure 701 and a material 702. The frame structure 701 may be collapsable. For example, the frame structure 701 may include origami features to allow for the collapsable nature of the frame structure 701. The material 702 may include FPC to collect solar energy.

### Example Additional Embodiments

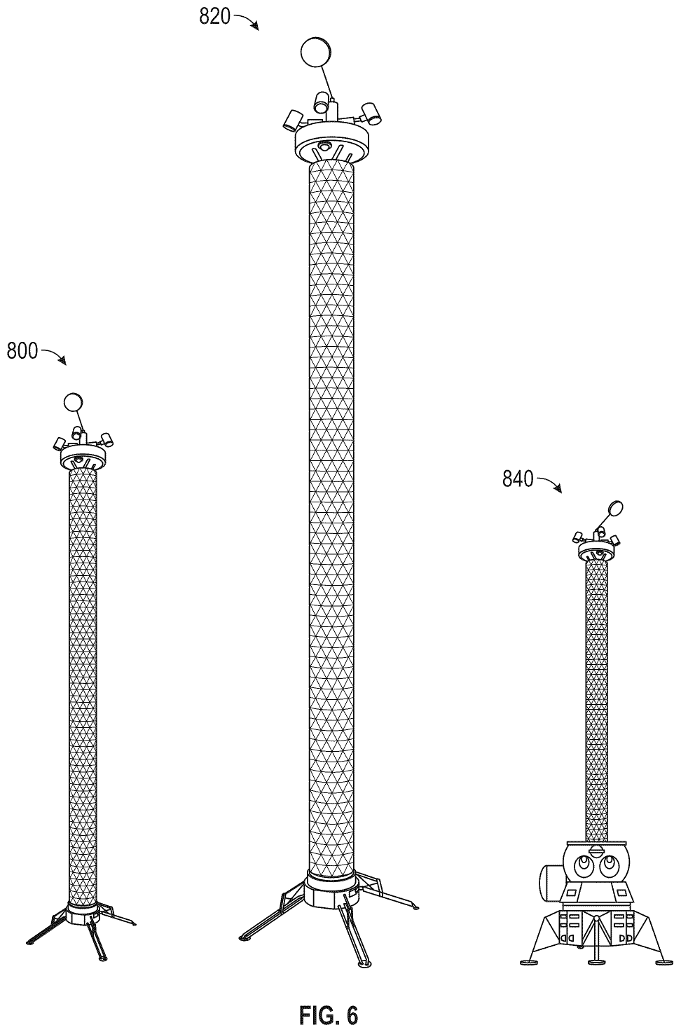

FIG. 6 illustrates various embodiments of stations as disclosed herein. As illustrated, FIG. 6 includes a first embodiment 800, a second embodiment 820, and a third embodiment 840 of stations 101, 102, 103, 300. The first embodiment 800 includes a deployable structure designed to integrate functionality as disclosed herein. For example, energy harvesting, storage, communications, mesh networking, Position, Navigation, and Timing (PNT), power transfer, and surveillance. The first embodiment 800 features a base section providing stability and support, a mast section extending to 100 m, and a top section equipped with various components for energy transfer, communication, and surveillance. The second embodiment 820 is a larger version of the first embodiment 800, extending to 200 m in height. The third embodiment 840 is a station integrated with a lander. The third embodiment 840 includes a base section attached to the lander, providing stability and support. The mast section extends to a height between 0 and 200 m. Embodiments of the station are designed to provide services such as energy harvesting, communication, and surveillance, ensuring robust functionality and continuous operation for lunar missions. The different heights and configurations allow for scalability and customization based on mission requirements, providing a versatile solution for various lunar operations. In some examples, the dimensions disclosed herein may be any value or range between any of the values or ranges or any value or range bounded by any combination of these values, although values or ranges outside these values or ranges can be used in some cases.

The stations as disclosed herein may include components and/or be able to provide services according to Table 1.

TABLE 1

| Service | Uses Cases |
|---|---|
| Solar Energy and | Lunar landers during landing, rovers, instruments, |
| Storage | payloads, habitats, ISRU equipment, and infrastructure |
| Power Transfer | Lunar landers during landing, rovers, instruments, |
| | habitats, ISRU equipment and infrastructure |
| Position, Navigation, | High precision positioning and landing for lunar landers, |
| and Timing (PNT) | rovers, astronauts, ISRU, etc. |
| Communications | Provides up/down link between all lunar assets and |
| | satellites and if positioned correctly, direct-to-Earth |
| | communications. |
| Data Storage | Data storage for instruments, monitoring data, etc. |
| Solutions | Option for RAID-10 for additional redundancy |
| Asset | Monitor deployed assets and EVAs for critical missions |
| Monitoring | and operations |
| Lighting for | Provide light sources for lunar exploration and help |
| Exploration | map terrain for future path planning |
| Lunar internet | Provide a reliable access to data and services within |
| grid | the reach of the deployed nodes |

The stations as disclosed herein may achieve performance characteristics according to Table 2.

TABLE 2

| | | | One embodiment | | Another embodiment | |
|---|---|---|---|---|---|---|
| Performance | Existing | | of stations 101, | | of stations 101, | |
| Metrics | systems | | 102, 103, 300 | | 102, 103, 300 | |
| Mission Life | 10 | years | 10 | years | 20+ years (with | |
| | | | | | reservicing) | |
| Deployment | 16 | m | 50 | m | 100 | m |
| height | | | | | | |
| Max Power | 10 | kW | 50 | kW | 150 | kW |
| generation | | | | | | |
| Power generation | 0 | kW | 8 kW (TBD on | | 20 kW (TBD on | |
| at Lunar Night | | | location and analysis) | | location and analysis) | |
| % Average Power | N/A | | 6% | | 94% | |
| Generation over | | | | | | |
| Lunar Year | | | | | | |
| Power | N/A | | 2 | km | 30 | km |
| transmission | | | | | | |
| horizon distance | | | | | | |
| Energy Storage | 5 | kWh | 10 | kWh | 50 | kWh |

| | | | |
|---|---|---|---|
| Interconnected | Stand-alone | Stand-alone | Utilized in a |
| Power Grid | | | network grid |
| Complexity | Requires actuation | 360 FOV solar | 360 FOV solar |
| | to turn to face the | panels; single time | panels; single time |
| | Sun | deployment | deployment |
| Re-servicing | Solar panels cannot | Solar panels cannot | Swappable solar |
| | be reserviced | be reserviced; tech | panels subsystem |
| | | demo only | |
| Communications | Relay comms | Utilizes lander | Local and DTE |
| | through TDRS | comms | comms |
| Asset Monitoring | Relies on external | Relies on external | Real-time 360 FOV |
| | assets such as LRO | assets such as LRO | cameras |
| | (every 2 hours) | (every 2 hours) | |

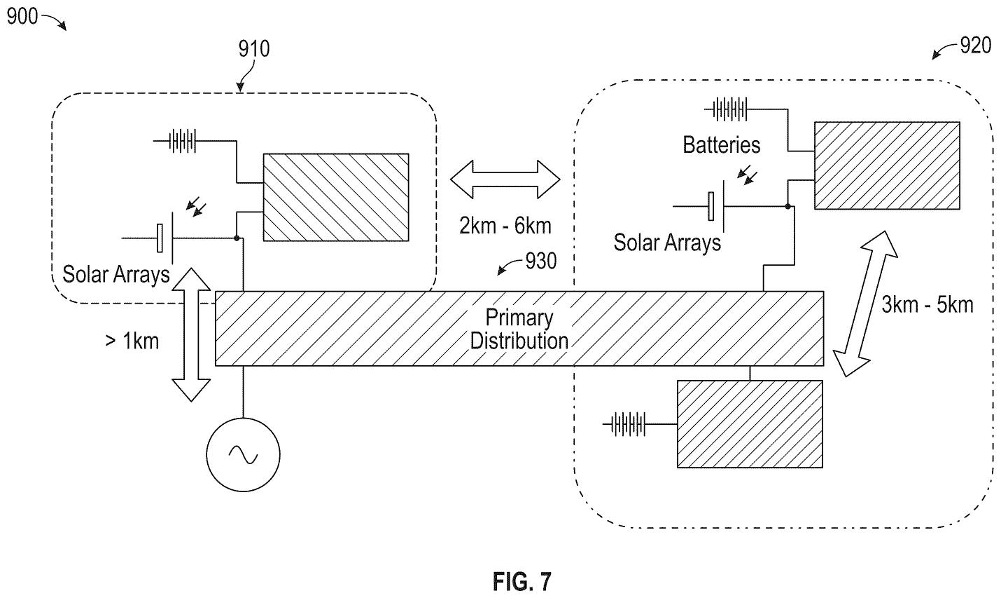

FIG. 7 illustrates an example circuit diagram 900 illustrating a comprehensive view of the energy distribution and management system designed for lunar applications. The circuit diagram 900 integrates multiple functionalities, including energy harvesting, storage, and distribution, to support various lunar operations. The circuit diagram 900 may provide efficient energy management and distribution across different lunar assets and infrastructure. In some examples, stations as described herein may provide power across a primary distribution 930 to a habitat 910 and ISRU system 920.

The habitat 910 represents the living quarters for astronauts on the lunar surface. The habitat 910 includes various components to ensure the safety and comfort of astronauts. The habitat 910 is designed to provide reliable energy, communication, and navigation support, enhancing the overall mission success. The habitat 910 is connected to solar arrays and batteries for energy storage, ensuring a continuous power supply. The habitat 910 may be constructed from lightweight, high-strength materials such as aluminum alloys or composite materials to ensure durability and case of deployment. In some examples, the habitat 910 may include additional components using power, for example, integrated thermal management systems, radiation shielding, and/or modular design elements. The habitat 910 may receive between 0 and 200 kW of power from the primary distribution 930 across varying distances. For example, the primary distribution 930 may provide the power to the habitat 910 via direct connection (such as the power cable 150 in FIG. 1) or wireless power transfer (such as power beam 160 in FIG. 1). In some examples, the power distribution 930 may provide power at distances between 0 and 5 kilometer (km) or more.

The ISRU system 920 represents the operations for extracting and processing lunar resources. The ISRU system 920 includes various components to support resource extraction and processing activities. The ISRU system 920 may provide reliable energy, communication, and navigation support, enhancing the overall efficiency and success of resource utilization operations. The ISRU system 920 is connected to solar arrays and batteries for energy storage, ensuring a continuous power supply. The ISRU system 920 may be constructed from durable materials such as stainless steel or advanced polymers to withstand the harsh lunar environment. In one embodiment, the ISRU system 920 may include automated systems for resource extraction and processing. In another embodiment, the ISRU system 920 may feature integrated sensors to monitor resource extraction and processing activities. A third embodiment may incorporate modular design elements, allowing for easy expansion and customization based on mission requirements. The ISRU system 920 may require 60 kW or more of power over long distances from the primary distribution 930. In some cases, lunar exploration may rely on the stations for power, each rover receiving 500 W from the primary distribution 930. For example, the primary distribution 930 may provide the power to the ISRU system 920 and the lunar exploration assets (such as the rover) via direct connection (such as the power cable 150 in FIG. 1) or wireless power transfer (such as power beam 160 in FIG. 1). In some examples, the power distribution 930 may provide power at distances between 0 and 5 km or more.

The primary distribution 930 represents the main distribution network for energy, communication, and navigation services on the lunar surface. The primary distribution 930 includes various components to ensure reliable and efficient delivery of services. The primary distribution 930 may provide comprehensive coverage and robust functionality, enhancing the overall mission success. The primary distribution 930 may connect to solar arrays, batteries, and fission surface power systems for energy storage and generation, ensuring a continuous power supply. The primary distribution 930 may include a variety of stations to provide energy, communication, navigation services, among other services as described herein.

### Example Thermal Dissipation System

FIG. 8 illustrates a station 1010 (for example, as disclosed herein) including a variable geometry radiator at the various stages of deployment. The station 1010 may be the same or different as stations 101, 102, 103, 300. The radiator provides thermal dissipation for lunar assets. For example, for providing thermal dissipation by plugging into the radiator allowing the lunar assets to offload thermal dissipation. The radiator may include features such as in-built fluid pump loops, accumulator, valves, and controllers. The radiator may adjust a position, which may impact the capability to provide thermal dissipation. For the radiator to adjust, the station 1010 may include mechanical components that gradually unfold or expand the radiator panels, allowing the station 1010 to start dissipating heat more effectively. As illustrated, the radiator may adjust to different positions. For example, the radiator may start from a first position, adjusting to a second position, and ending in a third position. The position of the radiator may adjust according to environmental factors. The function of the variable geometry radiator allows for efficient thermal dissipation for lunar assets. In some cases, the lunar assets may connect hardware to the thermal dissipation system and request to initiate thermal flow between the thermal dissipation system and the lunar asset.

As illustrated, the station 1010 may be in a first position (noted as 1010A in FIG. 8). The station 1010A in the first position shows a radiator in a first position 1011A. In this phase, the radiator is in a compact form factor. In this way, the radiator may be in an undeployed state. The first position may allow for transportation and deployment of the station 1010 on the lunar surface. The radiator may fold or retract to decrease volume during transit (or when adjusting to decrease volume, for example, when not in use). The station 1010 may be in a second position (noted as 1010B in FIG. 8). The station 1010B in the second phase shows an intermediate stage of the radiator 1011B deployment. In this phase, the radiator may adjust to increase surface area exposed to the lunar environment, thereby increasing capacity to provide thermal dissipation. The second phase may be a partially deployed state of the radiator. The station 1010 may be in a third position (noted as 1010C in FIG. 8). The station 1010C in the third phase depicts an extended position of the radiator 1011C. In this extended state, the radiator has reached a maximum surface area, forming a substantially flat plane, increasing for thermal dissipation.

FIG. 9A illustrates an example station 1100 including components that may provide dissipation of thermal energy. For example, the station 1100 includes variable geometry radiators. The variable geometry radiators may adjust positions according to environmental factors. In some examples, the station 1100 provides thermal flow to various lunar assets. The station 1100 may provide decreased weight due to consolidation of the station 1100 components. Consolidation of station 1100 components may decrease weight of entire station 1100. In this way, the variable geometry radiator may further decrease total weight of the station 1100 by adjusting positions according to environmental factors. For example, the radiator may adjust according to how much sun is shining at a location of the station 1100, how much shade is at the location of the station 1100, and/or does the sun and/or shade move with time, if so, the variable geometry radiator may adjust accordingly.

The station 1100 may include a base 1110, a radiator 1120, a payload 1130, and a thermal dissipation interface 1150. The base 1110 may provide an interface with the thermal dissipation interface 1150 and the radiator 1120. In this way, the base 1110 may include a mechanical fluid loop. The mechanical fluid loop may provide thermal transfer between a connected lunar asset form the thermal dissipation interface 1150 and the radiator 1120. The mechanical fluid loop may include a pump, accumulator, valves, and controllers. In some cases, the mechanical fluid loop may circulate coolant fluid throughout the station 1100. In some examples, the pump may drive the fluid through the loop, while the accumulator maintains the necessary pressure levels. The valves may control the flow of fluid to different parts of the station 1100, and the controllers manage the operation of the pump and valves based on the thermal demands of the connected users. The base 1110 may ensure that the coolant fluid is effectively distributed to absorb and dissipate heat from various payloads and users.

The radiator 1120 may provide for thermal dissipation from the payload to an external environment. For example, the radiator 1120 may provide passive thermal energy dissipation at least for the payload 1130. The radiator 1120 can adjust the configuration to increase thermal dissipation based on a thermal load and environmental conditions. The radiator 1120 geometry can change to increase or decrease the surface area exposed to the environment, thereby controlling the rate of heat dissipation. In this way, the flexibility allows the station 1100 to efficiently manage heat during both the lunar day and night, adapting to the varying thermal demands of the connected users.

The radiator 1120 may be coupled to the base 1110 and the mast section (such as mast section 302). The base 1110 may be a structural aspect from which the radiator 1120 extends. For example, the base 1110 may include a slot in which the radiator 1120 fits. In some examples, the base 1110 may include an actuator (and/or motor) to cause the radiator 1120 to extend from the base 1110. The actuator may drive the radiator 1120 to extend away from the base 1110. The radiator 1120 may extend away from the base 1110 and align with the mast section. For example, the mast section may include a track that guides the radiator 1120 as the radiator 1120 extends away from the base 1110. The radiator 1120 may include a guide component that, in some cases, couples to the track in the mast section. In this way, the track may guide the radiator 1120 as the radiator 1120 extends away from the base 1110. In some examples, the radiator 1120 includes a guide ring around the mast section that controls an orientation of the radiator 1120 as the radiator 1120 extends.

The radiator 1120 may include at least two sets of variable geometry radiators (for example, four sets of variable geometry radiators). A first set of the at least two sets of variable geometry radiators may be along a first side of the retractable mast and a second set of the at least two sets of variable geometry radiators may be along a second side of the retractable mast. The first side and the second side may be on opposite sides of the retractable mast. In some examples, the variable geometry radiator system comprises at least four sets of variable geometry radiators. In this way, each of the at least four sets of variable geometry radiators are positioned 90-degrees apart around the retractable mast to provide cooling 360-degrees around the mast section.

The payload 1130 can provide services and functionality to lunar assets. For example, the payload 1130 may serve as a power, communication, and navigation node, as described herein. For example, the payload 1130 may include solar panels, antennas, and other equipment to provide additional functionality. The payload 1130 can generate power, facilitate communication with other lunar systems or Earth, and provide navigation support for lunar operations.

In some examples, the payload 1130 may be solar panels that drape from the top section and collect solar energy. The station 1100 may rotate to a position to allow for solar power generation to achieve a target power cycle. For example, the target power cycle is generating solar power 90% of a time duration while the solar power system is deployed. In some cases, the station 1100 may rotate to the position to allow for the solar power generation to achieve the target power cycle and the payload remains in a fixed position.

The thermal dissipation interface 1150 may further include a self-leveling base 1151, a base load waste heat generator 1152, a variable demand user 1153, an excess power curtailment component 1154, a heat exchanger 1155, and additional thermal dissipation connections 1156. The self-leveling base 1151 may provide structural support for the station 1100. The self-leveling base 1151 may ensure the station 1100 remains stable and properly oriented on potentially uneven surface. The self-leveling base 1151 can adjust the station 1100 position to maintain a level platform, which is necessary for the optimal operation of the other components.

The base load waste heat generator 1152, such as a fission surface power (FSP) system or in-situ resource utilization (ISRU) system, generates significant amounts of waste heat that need to be managed. This component connects to the station 1100 to offload the thermal energy, which is then dissipated through the radiators or stored in the thermal battery. The integration of high-heat-generating users into the system allows for efficient thermal management and reduces the need for individual thermal control systems for each user.

The variable demand user 1153 may include lunar assets relying on radiative heat transfer for thermal management. The variable demand user 1153 may actively circulate coolant fluid and/or implement thermal dissipation. In some examples, the variable demand user 1153 may interface with the radiator 1120 to ensure efficient heat transfer, leveraging adjustable surface area of the radiator 1120 to maintain thermal conditions above a threshold.

The excess power curtailment component 1154 may manage the distribution of excess thermal energy generated by the station 1100. The excess power curtailment component 1154 may ensure that any surplus heat is effectively dissipated or stored, preventing overheating and maintaining system stability. The excess power curtailment component 1154 interfaces with the thermal battery or capacitor and the variable geometry radiator to balance the thermal load and optimize energy usage.

The heat exchanger 1155 connects the station 1100 to a secondary loop. For example, the second loop may include a fluid loop, such as the Environmental Control and Life Support System (ECLSS) or other low-temperature systems. The heat exchanger 1155 may transfer thermal energy from the primary loop (e.g., the station 1100) to the secondary loop, enabling efficient heat management across different subsystems. The heat exchanger 1155 may ensure that excess heat from high-temperature users can be effectively dissipated or stored, maintaining optimal operating temperatures for all connected systems. The additional thermal dissipation connections 1156 may provide further connections for lunar assets to interface with the thermal dissipation station 1100.

FIG. 9B illustrates an example station 1100 including components that may provide dissipation of thermal energy. For example, the station 1100 includes variable geometry radiators. The variable geometry radiators may adjust positions according to environmental factors. In some examples, the station 1100 provides thermal flow to various lunar assets. The station 1100 may provide decreased weight due to consolidation of the station 1100 components. Consolidation of station 1100 components may decrease weight of entire station 1100. In this way, the variable geometry radiator may further decrease total weight of the station 1100 by adjusting positions according to environmental factors. For example, the radiator may adjust according to how much sun is shining at a location of the station 1100, how much shade is at the location of the station 1100, and/or does the sun and/or shade move with time, if so, the variable geometry radiator may adjust accordingly

The station 1100 may include a base 1170, a thermal consolidation system 1175, a radiator 1180, a first payload 1190, and a second payload 1195. The base 1170, radiator 1180, first payload 1190, and second payload 1195 may be as described herein (such as the base 1110, radiator 1120, and payload 1130).

The thermal consolidation system 1175 may maintain thermal energy in an enclosure that surrounds the base 1170. The thermal consolidation system 1175 may include a tent that extends circumferentially around the mast section. The tent may provide for shielding of the contents of the enclosure. For example, the tent may shield the contents from direct sunlight. The tent may extend around the mast section with a diameter of between about 0 m and about 30 m, or any value or range between any of these values or ranges or any value or range bounded by any combination of these values, although values or ranges outside these values or ranges can be used in some cases. In some examples, the tent may include a height of between about 0 m and about 10 m, or any value or range between any of these values or ranges or any value or range bounded by any combination of these values, although values or ranges outside these values or ranges can be used in some cases. In some cases, the thermal consolidation system 1175 may be coupled to the mast section.

In some examples, the radiator 1180 may extend downward from a top portion of the mast section. For example, the radiator 1180 may couple to one or more arms that extend from the top portion of the mast section along an axis perpendicular to arms of the second payload 1195.

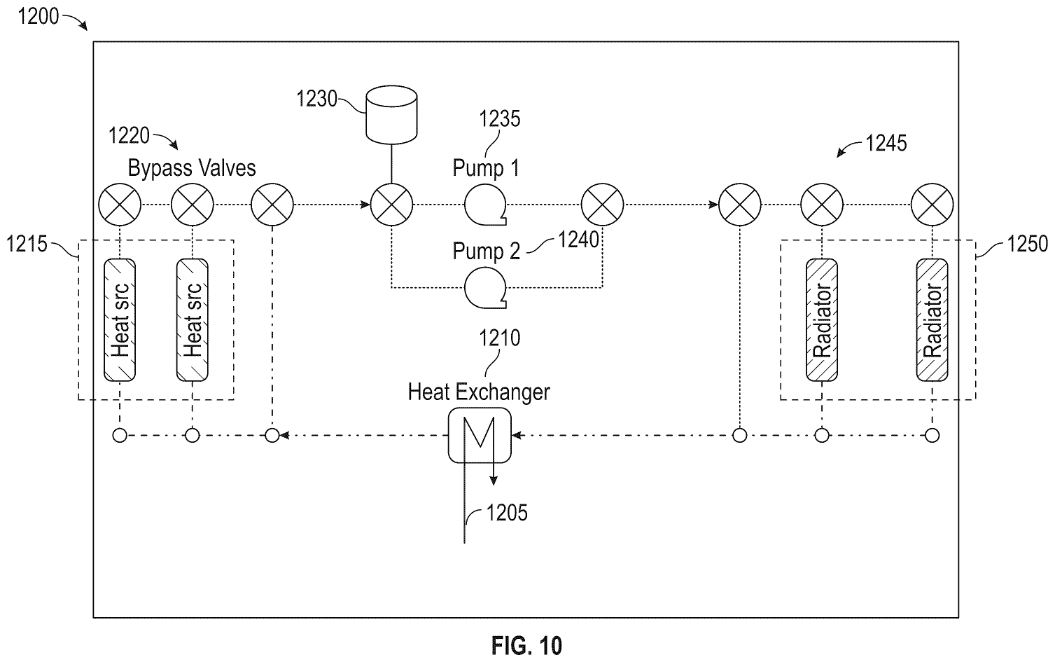

FIG. 10 illustrates a thermodynamic architecture 1200 for efficient thermal dissipation. In some cases, the architecture may provide thermal regulation for daytime and nighttime environments. For example, to withstand lunar daytime and nighttime. The thermodynamic architecture 1200 may allow for the various applications due to a variable geometry of the radiator as disclosed herein. The variable geometry adjusts thermal dissipation and radiator efficiency according to the geometry. The variable geometry allows for adjustable thermal densities of the thermodynamic architecture 1200. By consolidating the thermal radiator requirements, the thermodynamic architecture 1200 may apply active heat transport system and passive thermal dissipation architectures. For example, as part of the active heat transport, the thermodynamic architecture 1200 may include 2-phase pumped fluid loops to enable increased thermal densities without significantly increasing mass of the thermodynamic architecture 1200. In some examples, as part of the passive thermal dissipation, a two-sided deployable radiator with solar off-pointing may increase radiator thermal dissipation per unit mass (kW/kg) by a factor of 2 at certain locations. For example, at the lunar south pole and more at equatorial regions. In some cases, when combined with higher temperature users (such as SFP and ISRU), radiator efficiency can increase an order of magnitude above traditional Lunar surface radiators. The thermodynamic architecture 1200 may include a heat management interface 1205, a heat exchanger 1210, heat sources 1215, first bypass valves 1220, an accumulator 1230, a first pump 1235, a second pump 1240, second bypass valves 1245, radiators 1250.

The thermal interface 1205 may be an interface between a connection point for lunar assets that seek to offload thermal energy into the primary thermal management system (for example, the station 1100 in FIG. 9A). The thermal interface 1205 may include dust-tolerant fluidic connectors (such as the DTC described herein) or attachable heat plates, which ensure reliable connections in the harsh lunar environment. When a secondary user connects to the thermal interface 1205, the heat generated by the user is absorbed by the coolant fluid circulating through the architecture 1200. The fluidic connectors may ensure a secure and efficient transfer of thermal energy from the lunar asset to the heat exchanger 1210.

The heat exchanger 1210 may transfer thermal energy from a primary fluid loop to a secondary loop. The transfer of thermal energy may provide efficient thermal management across different subsystems, maintaining operating temperatures for the lunar assets and the thermodynamic architecture 1200. The heat exchanger 1210 may allow the thermal architecture 1200 to balance the thermal load and prevent overheating.

The heat sources 1215 may be primary sources of thermal energy within the architecture 1200. The heat sources 1215 may include various payloads or equipment generating heat that seek thermal management. The heat sources 1215 are connected to the first bypass valves 1220.

The first bypass valves 1220 may control the flow of coolant fluid within the thermal architecture 1200. The first bypass valves 1220 can direct the fluid through the heat sources 1215 to absorb heat or bypass them as needed. The first bypass valves 1220 may ensure that the architecture 1200 can adapt to varying thermal loads and maintain optimal performance.

The accumulator 1230 may store excess coolant fluid and maintains pressure levels within the architecture 1200. The accumulator 1230 may accommodate thermal expansion and contraction of the fluid, ensuring stable operation. The accumulator 1230 may operate with the pumps 1235, 1240 and valves 1220, 1245 to regulate the flow and pressure of the coolant fluid.

The first pump 1235 and the second pump 1240 may circulate the coolant fluid throughout the architecture 1200. The pumps 1235, 1240 may drive the fluid through the various components, ensuring continuous heat transfer from the heat sources 1215 to the radiators 1250. The pumps 1235, 1240 may adjust pumping states and operations in response to controllers of the thermal architecture 1200, which may adjust pumping states and operations based on the thermal demands of the connected users.

The second bypass valves 1245 may control the flow of coolant fluid to and from the radiators 1250. The second bypass valves 1245 may regulate the amount of fluid passing through the radiators 1250, adjusting the heat dissipation rate according to thermal management operations. The second bypass valves 1245 may ensure that the radiators 1250 operate efficiently and maintain the desired thermal balance.

The radiators 1250 may transfer thermal energy from the coolant fluid to the external environment, effectively dissipating thermal energy. The radiators 1250 may include geometries to maximize surface area and thermal radiation, ensuring efficient heat management. For example, the radiators 1250 may include variable geometries as disclosed herein. In some examples, the radiators 1250 may include a single radiator or multiple radiators to handle different thermal loads and maintain stable temperatures.

### Example Station Having One or More Adjustable Arms

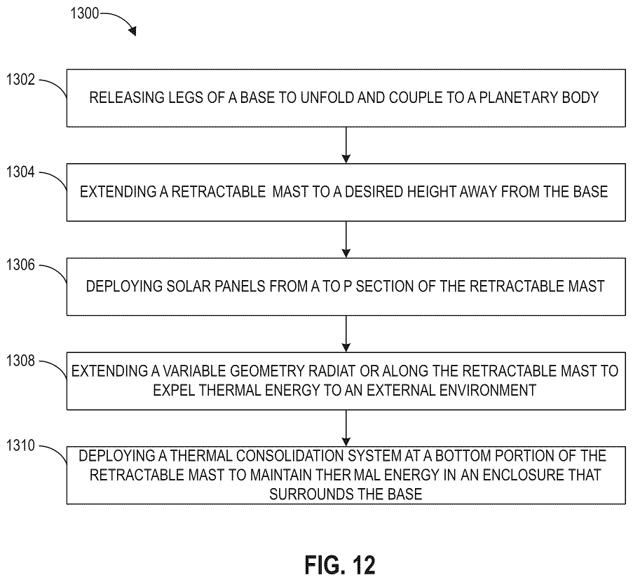

FIGS. 11A-11B illustrate example stations including one or more adjustable arms. In some examples, a station, as disclosed herein, may include one or more adjustable arms (for example, the stations 101, 102, 103, 300, 1010 of FIGS. 1, 3, and 10, respectively). The stations may be configured to be in various positions. For example, the stations may be in a first position (such as shown in FIG. 11B) to be stowable in a spacecraft. The stations may be in a second position (such as, shown in FIGS. 1, 3, and 10) to be deployable on a surface (such as a planetary body). In some examples, the stations may be self-deployable (such as described in FIG. 12). For example, the stations may include a computing system to control deployment of the station components.

In some examples, an adjustable arm may be part of a top section connected to a mast section or the station. In some cases, the adjustable arm may include a cantilever design, having a fixed end and a free end. The adjustable arm may have the fixed end coupled to the station. In some cases, the adjustable arm may rotate at (or near) the fixed end.

The adjustable arm may include a plurality of sections. For example, the adjustable arm may include at least one section, and in some cases, are able to adjust a position. In some examples, each of the plurality of sections may be a cantilever design. In some examples, each of the sections of the adjustable arm may interconnect, allowing for various geometries of the adjustable arm. The sections may be adjustable by rotating along a fixed end.

In some cases, the plurality of sections may pivot with respect to one another at a first interconnect (for example, the first interconnect couples each of the sections together). Although the plurality of sections may include more (or fewer) than two sections, for the purpose of explanation, the disclosure may focus on explaining the plurality of sections as having two sections. For example, the sections may be positioned in various configurations. In a first configuration, such as a folded configuration, a first section may adjust in such a manner that a second section may be parallel (or substantially parallel) to the first section (for example, the first section and the second section are 0-degrees, 180-degrees, or 360-degrees). In a second configuration, the first section may fold in such a manner that the second section may be perpendicular (or substantially perpendicular) to the first section (for example, 90-degrees or 270-degrees). In some examples, the first section (or another section) may adjust with respect to the second section (or another section) from the first configuration to the second configuration, or to a position in between the mast configurations (for example, at a position between 0-degrees and 360-degrees). The plurality of sections may adjust a position in any of three dimensions according to the capabilities of the first interconnect with each of the other sections (such as rotating along X-Y-Z planes).

In some cases, the plurality of sections may pivot with respect to the mast section at a second interconnect (for example, the second interconnect couples one of the plurality of sections to the mast section). For example, in a first mast configuration, one or more of the sections may be positioned parallel (or substantially parallel) to the mast section (for example, the plurality of sections pivoting 0-degrees or 180-degrees). In a second mast configuration, one or more of the sections may be positioned perpendicular (or substantially perpendicular) to the mast section (for example, the plurality of sections pivoting 90-degrees). In some examples, the plurality of sections may pivot such that the plurality of sections may adjust from the first mast configuration to the second mast configuration, or to a position in between the mast configurations (for example, at a position between 0-degrees and 180-degrees). The plurality of sections may adjust a position in any of three dimensions according to the capabilities of the second interconnect with the mast section (such as rotating along X-Y-Z planes).

In some examples, the station may include a plurality of adjustable arms. For example, the station may include two adjustable arms, each with a plurality of sections as disclosed herein. In some examples, the adjustable arms may provide structural support for the modular component, as described herein (such as described in FIG. 1). For example, the adjustable arms may provide structural support for a solar array. In this way, the adjustable arms may allow for the solar array to drape from the adjustable arms in a position to allow for solar power generation.

The sections of the adjustable arms may be made of material providing structural integrity applicable for terrestrial, extraterrestrial, and outer space, and any other application for the stations as disclosed herein. For example, the adjustable arms may be made of a type of metal providing lightweight and robust structural support, applicable for in-situ resource utilization. In some cases, the adjustable arms include a geometric structure. For example, the geometric structure may include a plurality of truss structures, in some cases, including a main beam structure and/or a jib section for rotating various truss structures.

In some examples, each of the plurality of sections may have a length that is between about 0 meters (m) and 200 m. In some examples, the length is between approximately 0 m and approximately 200 m, between approximately 25 m and approximately 175 m, between approximately 50 m and approximately 150 m, between approximately 75 m and approximately 125 m, between approximately 100 m and approximately 100 m, or any value or range between any of these values or ranges or any value or range bounded by any combination of these values, although values or ranges outside these values or ranges can be used in some cases.

In some examples, each of the plurality of sections may have a width that is between about 0 m and 20 m. In some examples, the length is between approximately 0 m and approximately 20 m, between approximately 5 m and approximately 15 m, between approximately 10 m and approximately 10 m, or any value or range between any of these values or ranges or any value or range bounded by any combination of these values, although values or ranges outside these values or ranges can be used in some cases.

In some examples, each of the plurality of sections may have a height that is between about 0 m and 20 m. In some examples, the length is between approximately 0 m and approximately 20 m, between approximately 5 m and approximately 15 m, between approximately 10 m and approximately 10 m, or any value or range between any of these values or ranges or any value or range bounded by any combination of these values, although values or ranges outside these values or ranges can be used in some cases.

A ratio between the length to the width may be between approximately 1 to approximately 200 (1:200), between approximately 1 to approximately 150 (1:150), between approximately 1 to approximately 100 (1:100), between approximately 1 to approximately 50 (1:50), between approximately 1 to approximately 1 (1:1), or any value or range between any of these values or ranges or any value or range bounded by any combination of these values, although values or ranges outside these values or ranges can be used in some cases.

A ratio between the width to the height may be between approximately 1 to approximately 20 (1:20), between approximately 1 to approximately 15 (1:15), between approximately 1 to approximately 100 (1:10), between approximately 1 to approximately 50 (1:5), between approximately 1 to approximately 1 (1:1), or any value or range between any of these values or ranges or any value or range bounded by any combination of these values, although values or ranges outside these values or ranges can be used in some cases. Alternatively, the ratio between the height to the width may have the same values as disclosed herein.

A ratio between the length to the height may be between approximately 1 to approximately 200 (1:200), between approximately 1 to approximately 150 (1:150), between approximately 1 to approximately 100 (1:100), between approximately 1 to approximately 50 (1:50), between approximately 1 to approximately 1 (1:1), or any value or range between any of these values or ranges or any value or range bounded by any combination of these values, although values or ranges outside these values or ranges can be used in some cases.

In some examples, the stations as disclosed herein may be similar or identical to and/or incorporate any of the features described and/or illustrated with respect to any of the devices, assemblies, systems, and/or methods described and/or illustrated in the Appendix.

### Example Method for Deploying a Station

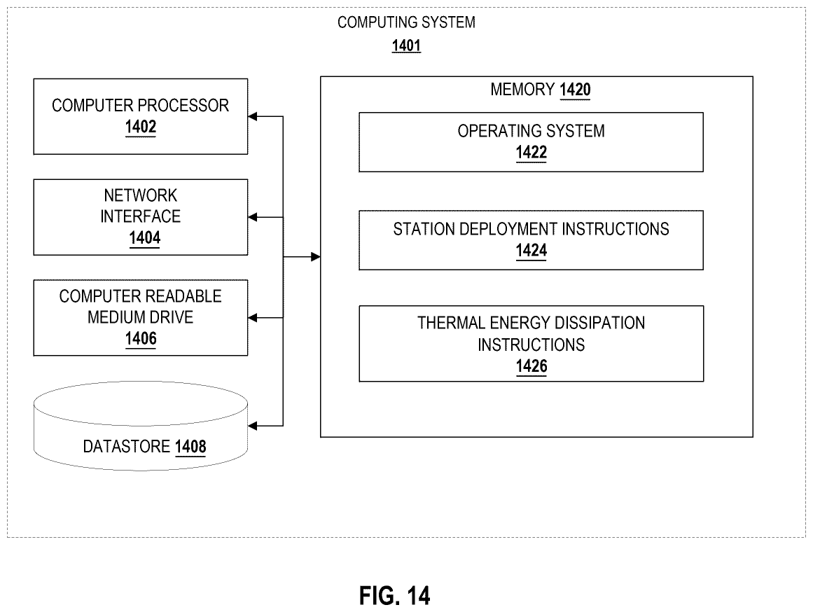

FIG. 12 is a flow diagram of an illustrative routine 1300 that may be executed by a computing system of a station (such as, stations 101, 102, 103, 300, 1010, 1100, 1160 of FIGS. 1, 3, 10, 11A-11B, respectively disclosed herein) to control deployment of the station on a planetary body. For example, the routine 1300 may be executed by the computing system 1401 to cause deployment of the station. The routine 1300 may begin in response to an event, such as receipt of instructions for the station to deploy. When the routine 1300 is initiated, a set of executable program instructions stored on one or more non-transitory computer-readable media (e.g., integrated circuit, hard drive, flash memory, removable media, and/or the like) may be loaded into memory (e.g., random access memory or “RAM”) of a computing device, such as the computing system 1401 shown in FIG. 14, and/or executed by one or more computing devices as disclosed herein (for example, an FPGA, an ASIC, a processor, and/or the like). In some embodiments, the routine 1300 or portions thereof may be implemented on multiple processors, serially or in parallel.

At step 1302, the computing system 1401 releases legs of a base to unfold and couple to a planetary body. For example, the station may be in a first position for stowing in a spacecraft. In the first position, the station may have the legs of the base in a folded configuration (for example, as shown in FIG. 11A and 11B). The computing system 1401 may determine the station is ready for deployment (for example, the station is in a desired location according to a terrain map, coordinates associated with the planetary body, and/or the like). In some examples, the computing system 1401 may release legs of the base in a manner as disclosed in FIG. 3 herein.

At step 1304, the computing system 1401 extends a retractable mast to a desired height away from the base. For example, the retractable mast may extend to the desired height by adjusting in a vertical direction upward from the base. The computing system 1401 may control the extension of the retractable mast, for example, via an actuator or other component in the base. The computing system 1401 may extend the retractable mast according to the approaches as described herein (for example, as described in FIG. 5A).

At step 1306, the computing system 1401 deploys solar panels from a top portion of the retractable mast. In some examples, the computing system 1401 may cause the solar panels to extend downward from the top portion of the retractable mast. In this way, the solar panels may collect solar energy. The computing system 1401 may deploy the solar panels according to the approaches as described herein (for example, as described in FIG. 5A).

At step 1308, the computing system 1401 extends variable geometry radiators along the retractable mast. In some examples, the variable geometry radiators may expel thermal energy associated with components of the station. For example, the variable geometry radiators may expel the thermal energy from a payload on the top section of the retractable mast to an external environment. In some examples, the variable geometry radiators may expel thermal energy associated with a lunar asset. For example, the lunar asset may attach to the base (for example, by using a DTC connector) and the variable geometry radiators may provide thermal dissipation for the lunar asset (for example, via active cooling as described in FIGS. 9A-10 herein).

At step 1310, the computing system 1401 deploys a thermal consolidation system at a bottom portion of the retractable mast. In some cases, the thermal consolidation system may extend radially from the retractable mast to capture thermal energy in an enclosed volume around the base. For example, the thermal consolidation system may be a tent positioned around the retractable mast to provide increased thermal energy capture of the enclosed volume. The computing system 1401 may deploy the thermal consolidation according to the approaches as described herein (for example, as described in FIG. 9B).

In the description herein, any blocks or steps described can include alternate implementations within the scope of the example embodiments of the present disclosure in which the blocks can be executed out of order from that shown or discussed, including substantially concurrently or in reverse order, depending upon the functionality involved, as would be understood by those skilled in the art. The various elements, features, and processes described herein may be used independently of one another or may be combined in various ways. All possible combinations and sub-combinations are intended to fall within the scope of this disclosure.

### Example Method for Dissipating Thermal Energy

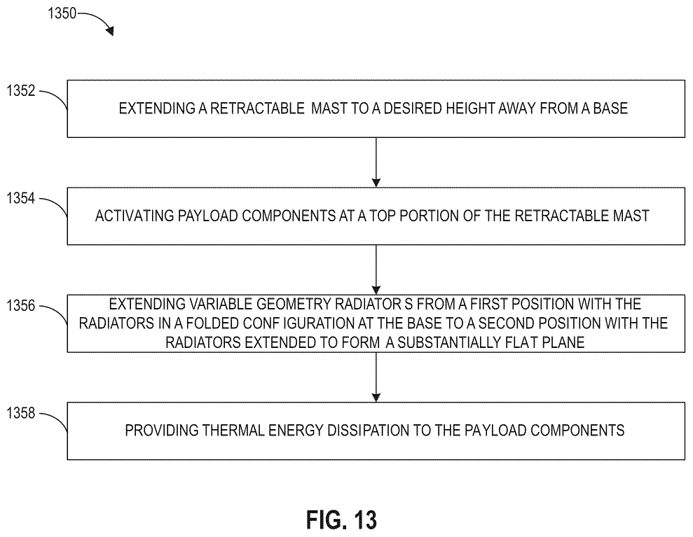

FIG. 13 is a flow diagram of an illustrative routine 1350 that may be executed by a computing system of a station (such as, stations 101, 102, 103, 300, 1010, 1100, 1160 of FIGS. 1, 3, 10, 11A-11B, respectively disclosed herein) to dissipate thermal energy from the station. For example, the routine 1350 may be executed by the computing system 1401 to cause dissipation of the thermal energy. The routine 1350 may begin in response to an event, such as receipt of instructions for the station to dissipate thermal energy. When the routine 1350 is initiated, a set of executable program instructions stored on one or more non-transitory computer-readable media (e.g., integrated circuit, hard drive, flash memory, removable media, and/or the like) may be loaded into memory (e.g., random access memory or “RAM”) of a computing device, such as the computing system 1401 shown in FIG. 14, and/or executed by one or more computing devices as disclosed herein (for example, an FPGA, an ASIC, a processor, and/or the like). In some embodiments, the routine 1350 or portions thereof may be implemented on multiple processors, serially or in parallel.

At step 1352, the computing system 1401 extends a retractable mast to a desired height away from a base. For example, the retractable mast may extend to the desired height by adjusting in a vertical direction upward from the base. The computing system 1401 may instruct the retractable mast (for example, via an actuator or other component in the base) to adjust a position of the retractable mast to the desired height. The computing system 1401 may adjust the height of the retractable mast according to the approaches as described herein (for example, as described in FIG. 5A).

At step 1354, the computing system 1401 activates payload components at a top portion of the retractable mast. In some cases, the computing system 1401 may provide an activation signal to the payload to cause the payload components to activate. For example, the computing system 1401 may identify whether the payload components are in direct light from a star (such as, the sun) and cause the payload components to activate. The computing system 1401 may identify the payload components are in the direct light due to the solar power system generating power.

At step 1356, the computing system 1401 extends variable geometry radiators from a first position with the radiators in a folded configuration at the base to a second position with the radiators extended to form a substantially flat plane. In some examples, the computing system 1401 may adjust a height of the variable geometry radiators to cause at least part of the variable geometry radiators to be in a shadowed portion of the retractable mast. The shadowed portion of the retractable mast may be caused by surrounding terrain that blocks at least some light of a star (for example, the sun). The variable geometry radiators being in a shadowed portion of the retractable mast may provide increased thermal dissipation due to cooler temperatures (based on the lack of direct light). In some cases, the variable geometry radiators includes at least two sets of variable geometry radiators to form one or more substantially flat plane (for example, one set of variable geometry radiators on a first side of the retractable mast and another set on a second side).

At step 1358, the computing system 1401 provides thermal energy dissipation to the payload components (and/or for the lunar asset). In some examples, the computing system 1401 may cause exchanging fluid with the payload components by using an active heat transport system. The active heat transport system may pump cooled fluid to the payload components and heated fluid to the radiators. In some cases, the thermal energy dissipation may rely on radiating thermal energy into an external environment surrounding the retractable mast. In some cases, the computing system 1401 may receive a connection from a DTC of a lunar asset. For example, the lunar asset may attach a DTC with the base and the computing system 1401 may determine the successful connection. The computing system 1401 may instruct to provide thermal energy dissipation to the lunar asset by using the approaches as described herein (for example, the active heat transport system).

In the description herein, any blocks or steps described can include alternate implementations within the scope of the example embodiments of the present disclosure in which the blocks can be executed out of order from that shown or discussed, including substantially concurrently or in reverse order, depending upon the functionality involved, as would be understood by those skilled in the art. The various elements, features, and processes described herein may be used independently of one another or may be combined in various ways. All possible combinations and sub-combinations are intended to fall within the scope of this disclosure.

### Example Computing System

FIG. 14 illustrates various components of an example computing system 1401 configured to implement various functionality of the computing system 1401 (for example, to deploy a station and/or control thermal energy dissipation, as described herein). In some embodiments, as shown, the computing system 1401 may include: one or more computer processors 1402, such as physical central processing units (“CPUs”), FPGAs, ASICs, and/or the like; one or more network interfaces 1404, such as a network interface cards (“NICs”); one or more computer-readable medium drives 1406, such as a high density disk (“HDDs”), solid state drives (“SSDs”), flash drives, and/or other persistent non-transitory computer-readable media; one or more datastore 1408, such as physical storage and/or remote storage, and/or other data storage components; and one or more computer-readable memories 1420, such as random access memory (“RAM”) and/or other volatile non-transitory computer-readable media.

The computer-readable memory 1420 may include computer program instructions that one or more computer processors 1402 execute in order to implement one or more embodiments. The computer-readable memory 1420 can store an operating system 1422 that provides computer program instructions for use by the computer processor(s) 1402 in the general administration and operation of the computing system 1401.

In some embodiments, the computer-readable memory 1420 can further include computer program instructions and other information for implementing aspects of the present disclosure. For example, the computer-readable memory 1420 may include station deployment instruction 1424 for deploying a station on a planetary body, as described herein. As another example, the computer-readable memory 1420 may include thermal energy dissipation instructions 1426 for controlling thermal energy dissipation, as described herein.

When a routine is initiated, a corresponding set of executable program instructions stored on a computer-readable medium drive 1406 may be loaded into computer-readable memory 1420 and executed by one or more computer processors 1402. In some embodiments, a routine-or portions thereof-may be implemented on multiple computing devices and/or multiple processors, serially or in parallel.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or logic circuitry that implements a state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements, or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A lunar structure comprising:
a base configured to provide active thermal energy dissipation;
a retractable mast coupled to the base, the retractable mast comprising deployable interlocking actuated bands, wherein the deployable interlocking actuated bands extend in a vertical direction upward from the base; and
a thermal dissipation system coupled to the base, the thermal dissipation system comprising a variable geometry radiator system configured to provide passive thermal energy dissipation, wherein the variable geometry radiator system comprises a radiator and is configured to adjust the radiator from a first position in which the radiator is in a folded configuration at the base to a second position in which the radiator is extended to form a substantially flat plane.

2. The lunar structure of claim 1, wherein the radiator extends from the first position to the second position by extending along an axis parallel with the retractable mast in a vertical direction upwards from the base, and wherein the second position results in the radiator forming the substantially flat plane in the vertical direction.

3. The lunar structure of claim 1, wherein the radiator is configured to adjust a position at least in response to an environmental condition.

4. The lunar structure of claim 1, wherein the thermal dissipation system is positioned in a portion of the lunar structure not exposed to direct sunlight.

5. The Lunar structure of claim 1, wherein the radiator comprises at least two sets of variable geometry radiators.

6. The lunar structure of claim 5, wherein a first set of the at least two sets of variable geometry radiators is positioned along a first side of the retractable mast, and a second set of the at least two sets of variable geometry radiators is positioned along a second side of the retractable mast.

7. The lunar structure of claim 6, wherein the first side and the second side are on opposite sides of the retractable mast.

8. The lunar structure of claim 1, wherein the variable geometry radiator system comprises at least four sets of variable geometry radiators.

9. The lunar structure of claim 8, wherein each of the at least four sets of variable geometry radiators are positioned 90-degrees apart around the retractable mast.

10. The lunar structure of claim 1, further comprising a thermal dissipation interface coupled to the variable geometry radiator system, wherein the thermal dissipation interface is configured to transfer thermal energy between a lunar asset and the variable geometry radiator system.

11. A method comprising:
extending a retractable mast to a desired height in a vertical direction upward from a base;
activating payload components at a top portion of the retractable mast;
extending a radiator from a first position in which the radiator is in a folded configuration at the base to a second position in which the radiator is extended to form a substantially flat plane; and
providing thermal energy dissipation to the payload components.

12. The method of claim 11 further comprising adjusting a height of the radiator to cause at least part of the radiator to be in a portion of a lunar structure not exposed to direct sunlight.

13. The method of claim 11, wherein providing the thermal energy dissipation to the payload components further comprising exchanging fluid with the payload components by using an active heat transport system.

14. The method of claim 13 further comprising pumping cooled fluid to the payload components and heated fluid to the radiator.

15. The method of claim 11 further comprising radiating thermal energy into an external environment surrounding the retractable mast.

16. The method of claim 11 further comprising receiving a connection from a dust-tolerant connector of a lunar asset.

17. The method of claim 16 further comprising providing thermal energy dissipation to the lunar asset.

18. The method of claim 16, wherein providing the thermal energy dissipation further comprising exchanging fluid with the lunar asset by using an active heat transport system.

19. The method of claim 18 further comprising pumping cooled fluid to the lunar asset and heated fluid to the radiator.

20. The method of claim 11 further comprising extending at least two sets of variable geometry radiators along an axis parallel with the retractable mast to form one or more substantially flat plane in the vertical direction.
